(19) United States
(12) Patent Application Publication
(10) Pub. No.: US 2025/0200763 A1
(43) Pub. Date: Jun. 19, 2025

(54) 4D FLUORESCENCE MICROSCOPY ORGANELLE NETWORK TRACKING

(71) Applicant: THE REGENTS OF THE UNIVERSITY OF CALIFORNIA, Oakland, CA (US)

(72) Inventors: Johannes SCHOENEBERG, La Jolla, CA (US); Zachary WANG, La Jolla, PA (US)

(21) Appl. No.: 18/832,021

(22) PCT Filed: Jan. 25, 2023
(86) PCT No.: PCT/US2023/061312

§ 371 Date: Jul. 22, 2024

Related U.S. Application Data
(60) Provisional application No. 63/267,129, filed on Jan. 25, 2022.

(51) Int. Cl. G06T 7/246; G06T 7/11

(52) U.S. Cl. CPC G06T 7/248; G06T 7/11; G06T 2207/10056; G06T 2207/10064; G06T 2207/30024

(57) ABSTRACT

Disclosed are devices, systems, and methods for temporal tracking of structures, such as cellular structures including organelle networks, in 2D or 3D time-lapse fluorescence microscopy data. A method for temporal tracking of cellular structures including organelle networks in fluorescence microscopy data is provided. The method comprises obtaining image data of a network in three spatial dimensions over time and processing the image data to track a movement of individual subcomponents of the network from a first frame to a second frame subsequent to the first frame.

### CROSS-REFERENCE TO RELATED APPLICATION(S)

This application claims priority to the provisional application with Ser. No. 63/267,129, titled “4D FLUORESCENCE MICROSCOPY ORGANELLE NETWORK TRACKING,” filed on Jan. 25, 2022. The entire content of the above-noted provisional applications is incorporated by reference as part of the disclosure of this document.

### TECHNICAL FIELD

The present technology pertains to fluorescence microscopy technology, including computational techniques for tracking structures in fluorescence micrographs.

### BACKGROUND

Fluorescence microscopy imaging is a non-invasive imaging technique that can visualize biological structures and processes in a living organism. Fluorescence is a form of luminescence that results from matter emitting light of a certain wavelength after absorbing electromagnetic radiation. Molecules that re-emit light upon absorption of light are called fluorophores.

### SUMMARY

Disclosed are devices, systems, and methods for temporal tracking of structures, such as cellular structures including organelle networks, in time-lapse fluorescence microscopy data, e.g., particularly lattice-light-sheet microscopy data.

In one example aspect, a method for temporal tracking of cellular structures including organelle networks in fluorescence microscopy data is provided to include obtaining image data of a network in three spatial dimensions and processing the image data to track a movement of individual subcomponents of the network from a first frame to a second frame subsequent to the first frame.

In another example aspect, a device including a processor to perform a method for temporal tracking of cellular structures including organelle networks in fluorescence microscopy data is provided. The method comprises: segmenting a network fluorescence signal to obtain a segmented network skeleton using a fluorescence signal and tracking a movement of nodes of the segmented network skeleton from a first frame to a second frame subsequent to the first frame.

In yet another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1A shows a diagram depicting an example embodiment of a method for segmenting a single-cell mitochondria and performing a network-level tracking of the 4D mitochondrial network in accordance with the present technology.

FIG. 1B shows a single cell segmentation in 3D time-lapse LLSM dataset done using a cell membrane marker.

FIG. 1C shows a segmentation of a mitochondria volume by a software tool based on a mitochondrial signal in an image as shown in FIG. 1B.

FIG. 1D shows a visualization of prototype tracking result that depicts mitochondria skeletons in two consecutive frames.

FIGS. 2A and 2B show data plots depicting example data of tracking precision on synthetic dataset from example implementations in accordance with the present technology.

FIGS. 3A and 3B show data plots depicting distribution of graph size ratio for fission/fusion events from example implementations in accordance with the present technology.

FIG. 4A shows beads-on-a-string model for mitochondria network.

FIG. 4B shows images depicting an example of a particle-based simulation for mitochondria motility in accordance with example implementations of the present technology.

FIG. 5 shows an example of a tracking results in 4D.

FIGS. 6A and 6B show examples of a volume rendering of segmented mitochondria of one single cell obtained by a visualization software.

FIG. 7 shows an example of tracking results in 4D of a mitochondrial network which is similar to FIG. 1D.

FIGS. 8A and 8B shows experimental and simulated 4D mitochondria network topologies.

FIG. 9A shows a realization of a particle simulation for a 4D mitochondrial network according to a topology where fission and fusion reactions in the network are not included.

FIG. 9B shows an example of tracking results on synthetic 4D mitochondria network data as a ground truth to assess the precision and fidelity of the tracking.

FIGS. 10A and 10B show examples of graphs showing precision data for a network tracking performance where fission and fusion reactions of the network were left out.

FIG. 11A shows a realization of a particle simulation for a 4D mitochondrial network according to a topology depicted in FIGS. 8A and 8B where fission and fusion reactions in the network are included.

FIG. 11B shows an example of tracking results on synthetic 4D mitochondria network data with fission and fusion reactions included as a ground truth to assess the precision and fidelity of the tracking.

FIG. 12 shows an example of a graph showing the precision of tracking for a 4D network where fission and fusion reactions are included.

FIGS. 13A to 13G show an example of a model system of 4D mitochondrial network tracking and related data based on some implementations of the disclosed technology.

FIGS. 14A to 14H show example diagram of an algorithm design and in-silico validation of 4D mitochondria network tracking based on some implementations of the disclosed technology.

FIGS. 15A to 15I show examples of an in-vitro validation and an evaluation of 4D mitochondria network tracking based on some implementations of the disclosed technology.

FIGS. 16A to 16I show example results of a mitochondrial network motility analysis based on some implementations of the disclosed technology.

FIGS. 17A to 17D show example results of a mitochondrial network remodeling analysis based on some implementations of the disclosed technology.

FIGS. 18A to 18H show example diagrams illustrating temporal characteristics of mitochondrial network remodeling, flux, and damage resilience based on some implementations of the disclosed technology.

FIGS. 19A to 19E show an example of a cell segmentation workflow based on some implementations of the disclosed technology.

FIGS. 20A and 20B illustrate the graph comparison algorithm at the center of the topology score calculation based on some implementations of the disclosed technology.

FIG. 21 shows a diagram illustrating a memory-efficient gap closing scheme using overlapping cost matrix blocks based on some implementations of the disclosed technology.

FIGS. 22A to 22C show examples of network metrics for the mitochondrial simulation.

FIG. 23 shows an algorithm for fission/fusion detection based on node tracking.

FIGS. 24A to 24F show simulation results on mitochondrial skeleton node diffusivity.

FIGS. 25A and 25B illustrate schematics for material diffusion simulation on temporal network.

FIG. 26 shows an example of a flowchart of a method for temporal tracking of cellular structures including organelle networks in fluorescence microscopy data.

### DETAILED DESCRIPTION

Disclosed are devices, systems, and methods for temporal tracking of structures, such as cellular structures including organelle networks, in time-lapse fluorescence microscopy data, e.g., particularly lattice-light-sheet microscopy data. In some embodiments, the disclosed devices, systems, and methods include 4D fluorescence microscopy organelle network tracking For example, in some implementations, cellular organelle network can be temporally tracked from segmented organelle network fluorescence lattice light-sheet data. The network tracking techniques suggested in this patent document can be applied to fluorescence microscopy data in two dimensional or three dimensional.

Lattice light-sheet microscopy (LLSM) is a type of fluorescence microscopy that allows imaging of biological specimen as three-dimensional movies. This capability is unprecedented and so are the datasets that come from these microscopes. Like with every type of microscopy, the value is not in the image itself but in the quantitative analysis of the images. The disclosed technology is designed to process this data and/or provide the processed data. Some example uses of the processed data by the disclosed devices, systems, and methods include phenotypic screening of reactions of biological cells and tissues to application of drug molecules in biotechnology.

Mitochondria are critically important in health and disease since they generate up to 90% of cell's energy. Despite the classic depiction as static beads, a mitochondria needs to be considered as four-dimensional (4D) tubular networks that span all three spatial dimensions and constantly undergo dynamic remodeling through fission and fusion. Historically, these 4D networks have eluded quantitative interrogation due to limitations in microscopy technology. With the advent of a new microscopy technology, lattice light-sheet microscopy (LLSM), the implementations of the disclosed technology provide techniques to make it possible to capture the 4D mitochondrial network. The implementations of the disclosed technology further suggest algorithmically tracking the networks and capturing their dynamic motion and remodeling events, which can fundamentally advance the study of mitochondria biology, particularly in the field of mitochondrial quality control. Some implementations of the disclosed technology employ advanced quantitative imaging to define the relationship between form and function in mitochondrial networks and to discover pharmacological interventions to restore mitochondrial health in disease.

Mitochondria are membrane-bound organelles in eukaryotic cells that provide the majority of energy for biological processes. In addition to energy production, mitochondria have diverse functions from storage and release of calcium ions (Ca²⁺) to cellular decision on growth and apoptosis by integrating metabolic states and environmental cues. Due to their bacterial ancestry, mitochondria also contain a multi-copy circular genome, the mitochondrial DNA (mtDNA), that encodes genes required for macromolecule biosynthesis and energy production.

Mitochondria vary in number, volume fraction, and shape among different cell types and cellular states. In mammalian cells, mitochondrial morphology ranges from discrete vesicle-like puncta to highly branched 3D tubular networks. Mitochondria also undergo dynamic changes through fission and fusion events. Fusion can facilitate the exchange of materials and enhance the diffusive search of reactants and increase energy production. Fusion between healthy and defect fragments also buffers toxic reactive oxygen species (ROS) and damaged mtDNA and compensates for reduced metabolic activity. As a necessary reverse process, fission is important for breaking up large mitochondria for degradation, active transport, and cell division. Loss of either fission or fusion ability results in significantly impaired cellular respiration. The balance of fission and fusion events is intricately regulated in response to the energetic state and environmental stress of the cell. Dysregulation in mitochondrial dynamics have been linked to aging, cancer, metabolic disorders, and neurodegenerative diseases such as Alzheimer's, Parkinson's, and Huntington's disease.

Quantitative analysis of both static morphology and dynamic events have been instrumental in studying mitochondrial form and function. Mitochondrial morphology clearly correlates with various functional readouts, such as membrane potential, remodeling event, and apoptosis. Dynamic analysis of fusion, fission events also yield numerous biological insights. However, all of these studies focus on 2D mitochondria planar images instead of more accurate 3D structures. Volumetric reconstruction of mitochondria from high-resolution 2D scanning electron microscopy sections demonstrate that while the 2D projection is smooth and elliptical, the 3D structure can be interconnected and elongated in the z-axis. Confocal airy scan and more advanced spinning disk confocal microscopy are frequently used to acquire 3D image stacks. Nonetheless, confocal systems use high light intensity to illuminate the sample resulting in comparatively short imaging times due to photobleaching and phototoxicity. In order to observe the dynamic motion and events mitochondria undergoes in 3D space, an imaging technology needs to achieve high volumetric frame rates while operating at low levels of phototoxicity to enable prolonged undisturbed imaging. In the example below, the 3D image data with capabilities of capturing more dynamic motion and events is mainly discussed, but the network tracking schemes suggested in this patent document can work with the image data in 2D as well.

Lattice light-sheet microscopy (LLSM) is a tool uniquely suited for such a purpose. It generates a thin light-sheet that eliminates out-of-focus signal and unintended photobleaching. LLSM can acquire a full z-stack of a single cell in ˜1 s, resulting in volumetric imaging of the mitochondrial network without considerable asynchronous motion along z-planes. LLSM also permits long-time imaging for tens of minutes without significant photobleaching, ideal for observing rare events and long-range movements of mitochondria.

### Item 1: Example Embodiments of Mitochondria Network Tracking Algorithm for Volumetric Fluorescence Microscopy Data.

The rapid departure from 2D imaging and the emerging capability to conduct 4D volumetric imaging poses a pressing need for advances in image processing. Two steps are usually needed to process 4D mitochondria datasets: 1) segmentation is first performed to separate mitochondria volume from the background; 2) tracking is then performed to link the segmented mitochondria over time for downstream analysis. Image smoothing followed by thresholding is frequently done for 2D segmentation, but 3D segmentation requires more careful treatments by a software such as MitoGraph. MitoGraph is mentioned as an example of an image processing/analyzing tool and other software tools can be used without being limited to MitoGraph. For tracking, however, so far there has not been an algorithm capable of tracking 3D mitochondria networks over time. Multiple tools have demonstrated tracking of 2D cross-sections of mitochondria fragments. A recently developed tool called Mitometer brings mitochondria tracking to 3D, but its shortcoming is the treatment of each mitochondrion as a single object rather than a network. Thus, even though network architecture is particularly useful for quantitative analysis and implicated in disease, none of the existing mitochondria tracking techniques (e.g., software/algorithms) is designed to handle 3D tubular networks. To explore the unique dataset the LLSM technology offers, it is necessary to design and implement a tracking algorithm that works with 4D mitochondrial networks.

4D mitochondrial networks can be reliably tracked over time by considering the network topology information. The linear assignment approach can be used for tracking nodes along the mitochondria skeleton and to incorporate the network's topology into the cost matrix. The tracking results will be validated through synthetic simulations, and visually inspected against experimental data. An algorithm is capable of high-fidelity tracking of the 4D mitochondrial network in 4D LLSM data.

Example Approach. To track 4D mitochondrial networks, a reduced model of mitochondria (e.g., generated by MitoGraph) can be used. MitoGraph discretizes mitochondria skeleton into individual nodes. Each node is connected to its neighboring nodes on the skeleton network, and have attributes such as spatial coordinates, intensity, and tubular width. The tracking of mitochondria thus boils down to assigning the nodes in the network at frame t to the nodes at frame t+1. Such assignments have been explored in mathematics as the Linear Assignment Problem (LAP) and can be solved with, for example, the Jonker-Volgenant algorithm in O(N³). This algorithm inputs a 2D cost matrix, which specifies the artificial cost for assigning nodes at frame t to nodes at t+1, and solves for the optimal node pair assignment that globally minimizes the sum of such costs. Therefore, a reliable assignment of mitochondria network nodes can be achieved by designing a cost matrix that captures some temporally preserved properties distinct for each small segment.

The implementation of the cost matrix is a combination of three independent terms. Terms in the cost matrix for LAP are as follows:

Spatial distance. Itis assumed that at high frame rate, the distance one fragment travels is less than the average spacing between fragments.

Pixel-based information. It is assumed that different parts along mitochondria network have varying tubular width and fluorescence intensity.

Local graph matching score (LGMS). It is assumed that mitochondria network tends to maintain local topology for certain time window.

The first term is the spatial distance or Euclidean distance. However, distance cost quickly decorrelates with node identity at increasing temporal distance between frames and is particularly insufficient for tracking networks because the characteristics of nodes are entirely neglected. Tracking of graph nodes, instead of entire fragments, demands a metric to distinguish individual connected segments. Thus, the second term is pixel-based information, including but not limited to node fluorescence intensity and tubular width. The underlying motivation is that the non-uniform properties along the skeleton can be helpful for identifying different nodes, given sufficient frame rates.

The third term in the cost matrix is the local graph matching score (LGMS), which is formulated specifically for network tracking. Given two nodes on two mitochondrial graphs, the LGMS is calculated with the following steps: 1) perform the conversion of the local graphs around the two nodes to a simpler data structure called tree, 2) match the nodes in the two trees with a greedy algorithm, 3) compute the difference between the two trees. Effectively, by comparing the topological similarity of the local graph arounds the two nodes, the LGMS can pick out nodes that are similar in terms of network connectivity and position on the network. All three terms are multiplied with tunable weights to construct the final cost matrix.

The full 4D mitochondria network tracking algorithm will be evaluated on a synthetic dataset with diffusing mitochondrial networks as the ground-truth. The implementation of simulation is discussed in the ‘Example Approach’ section in Item 3.

Expected Outcome. A high-fidelity algorithm that allows tracking of the 4D mitochondrial network in volumetric LLSM data.

Segmentation artifacts can generate temporally inconsistent structures and require filtering and coarse-graining in post-analysis. Fission/fusion events can break networks and render the topology-based metric less reliable. Nevertheless, since fission/fusion events happen once per 5-20 minutes per mitochondrion, LGMS is a reliable estimator at high volumetric frame rates (several seconds).

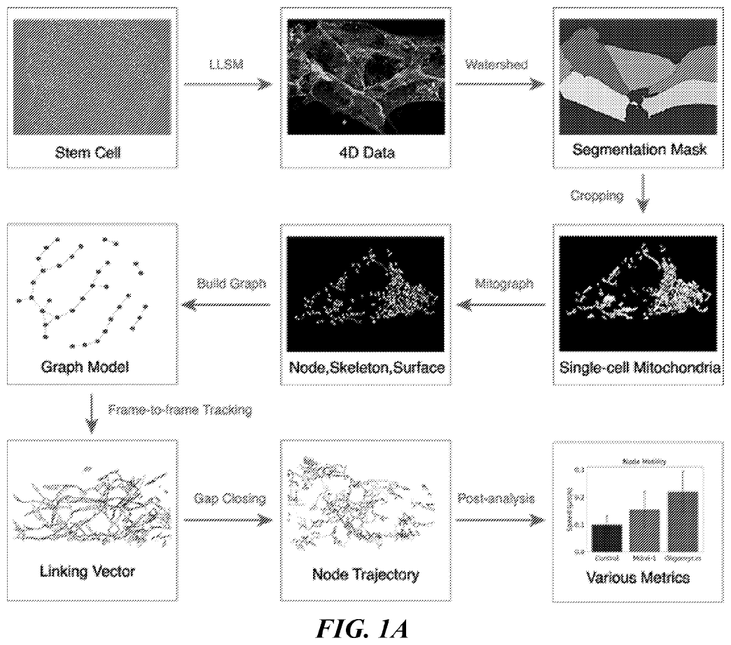

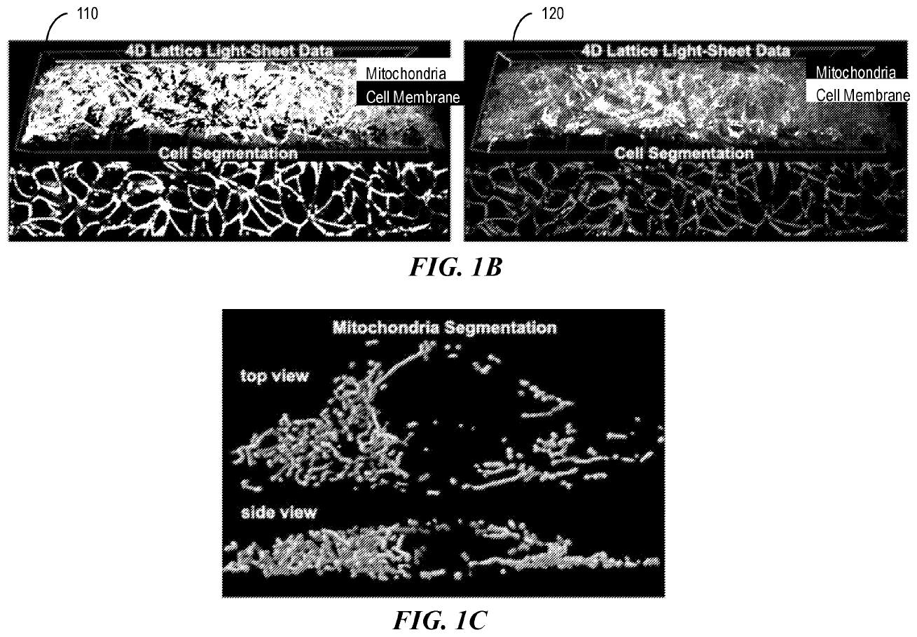

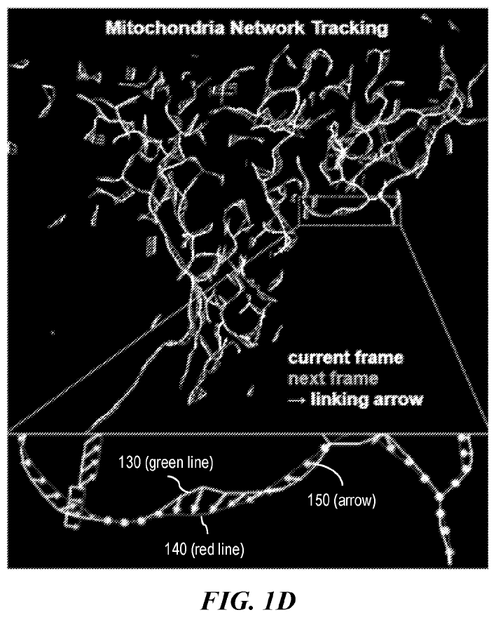

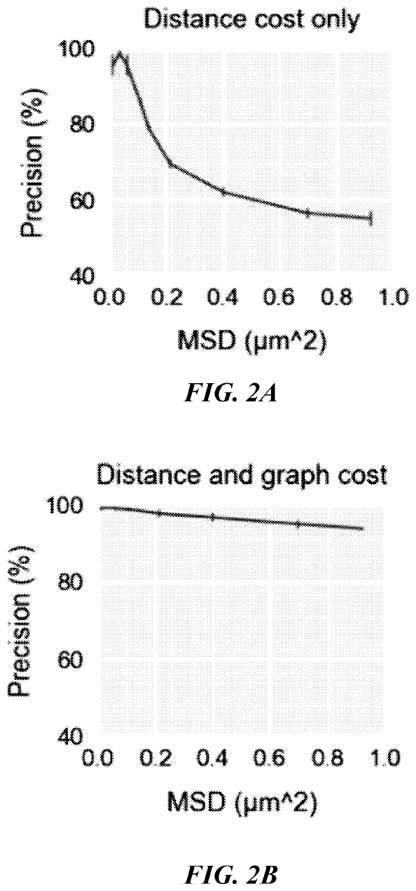

Preliminary results. A pipeline for segmenting single-cell mitochondria and performing network-level tracking of the 4D mitochondrial network is developed. A visualization of the pipeline and the network tracking performance are depicted in FIGS. 1A to 1D. Validation of an example prototype with ground truth data reveals that a high tracking precision is achieved by combining distance information with LGMS information, which is depicted in FIGS. 2A and 2B.

FIG. 1A shows a diagram depicting an example embodiment of a method for segmenting single-cell mitochondria and performing network-level tracking of the 4D mitochondrial network in accordance with the present technology.

FIGS. 1B to 1D show images depicting a mitochondria network segmentation and tracking pipeline in accordance with some example embodiments of the present technology. FIG. 1B shows a single cell segmentation in 3D time-lapse LLSM dataset. Two diagrams 110 and 120 on the left side and the right side of FIG. 1B show the images focused on the cell membrane and mitochondria, respectively. FIG. 1C shows a segmentation of mitochondria volume by Mitograph based on the mitochondrial signal. FIG. 1D shows a visualization of prototype tracking results. In FIG. 1D, mitochondria skeletons are depicted in two consecutive frames 130 and 140 (e.g., ˜3 sec) and linking arrows 150 between tracked nodes along the skeletons are shown.

FIGS. 2A and 2B show data plots depicting example data of tracking precision on synthetic dataset. Tracking precision is defined as the number of correct assignments over the total number of nodes. In the data plots, “MSD” stands for mean-square displacement, which is averaged over all nodes, and is proportional to the frame interval. FIG. 2A shows, with distance cost alone, the precision drops drastically at larger MSD. FIG. 2B shows, with distance and topology costs, a relatively high precision is maintained at high MSD.

### Item 2: Example Embodiments of Determining the Role of Mitochondrial Motility in Mitochondria Quality Control Using Quantitative 4D Imaging.

Mitochondria quality control (MQC) is a multi-step cellular process that 1) identifies dysfunctional mitochondria components, 2) isolates them from the healthy population, and 3) degrades them in autophagosomes in a process called mitophagy. There is converging evidence that steps 1 and 2 are achieved by selective fission/fusion dynamics. Careful regulation of this quality control system is important for human health. Selective fission has been directly observed, leading to the finding that position of fission partially determines the fate of daughter mitochondria. Selective fusion of healthy mitochondria fragments is proposed due to the fact that the fusion proteins require normal membrane potential to perform membrane fusion. System-level simulations also support that selective fusion could play a critical role in maintaining a healthy mitochondria population. Some implementations of the present technology demonstrate and characterize selective mitochondrial fusion through advanced 4D imaging and network tracking.

Mitochondrial motility complements selective fission/fusion events to facilitate quality control, through the action of the cytoskeleton. It has been observed that fragmented mitochondria have increased motility, potentially to enhance the probability of undergoing a rescue fusion event. Recent studies on mitochondria-cytoskeleton interactions demonstrate diverse ways the cytoskeleton has evolved to modulate mitochondrial function and may also regulate selective fission/fusion. Microtubules can inhibit mitochondrial fission by precluding fission proteins. Dynamic actin meshwork has been shown to organize and partition the mitochondria during mitosis, to tether mitochondria and limit their motility when glucose supply spikes.

Cytoskeleton-mediated mitochondria motility complements selective fission/fusion events to coordinate mitochondria quality control. LLSM imaging, drug treatments, and 4D mitochondrial network tracking can be combined to elucidate the interplay between mitochondrial motility and selective quality control with high spatiotemporal resolution. Full characterization of fission/fusion dynamics in 4D on the cellular mitochondrial network level can be obtained to reveal selective fission/fusion and clarify the involvement of the cytoskeleton.

Example Approach. To observe the interactions of mitochondria with other cellular structures, cell lines are used, where the cytoskeleton or autophagosome protein is genetically tagged with fluorescent proteins, and stain the mitochondria with dyes such as MitoTracker. To probe the activity of mitochondria, tetramethylrhodamine is used. The fluorescence intensity of tetramethylrhodamine is proportional to the mitochondrial membrane potential. Specific chemical species including ATP, ROS, and Ca²⁺ will also be probed with fluorescent sensors and used as readouts for the energetic and metabolic states of the cell during artificially created fission/fusion imbalances.

Pharmacological perturbations of mitochondria health, fission/fusion balance, and the cytoskeleton are the major avenue for studying mitochondria motility and MQC. To increase the population of damaged mitochondria available for mitophagy, inhibitors of key electron transport chain complexes such as rotenone and oligomycin are employed. To introduce an unbalanced fission/fusion dynamic, antagonists of key fission/fusion proteins (such as mdivi-1) can be utilized. Latrunculin or jasplakinolide is used to stop or enhance F-actin polymerization, and nocodazole will be used for the disassembly of microtubule network.

In-depth dynamic analysis is also crucial for deciphering the interplay. To detect fission and fusion events on a the 4D mitochondrial network level, computational tools that locate fission and fusion events are suggested.

Example Outcome. Quantitative statistics of mitochondrial motility and fission/fusion events in 4D that allows validation of selective fusion and cytoskeleton involvement in MQC.

Finer structures such as the cytoskeleton may be difficult to resolve in standard LLSM (˜200 nm lateral resolution). In some implementations, the LLSM in structured illumination microscopy (SIM) mode can be used to reach a lateral resolution of ˜80 nm.

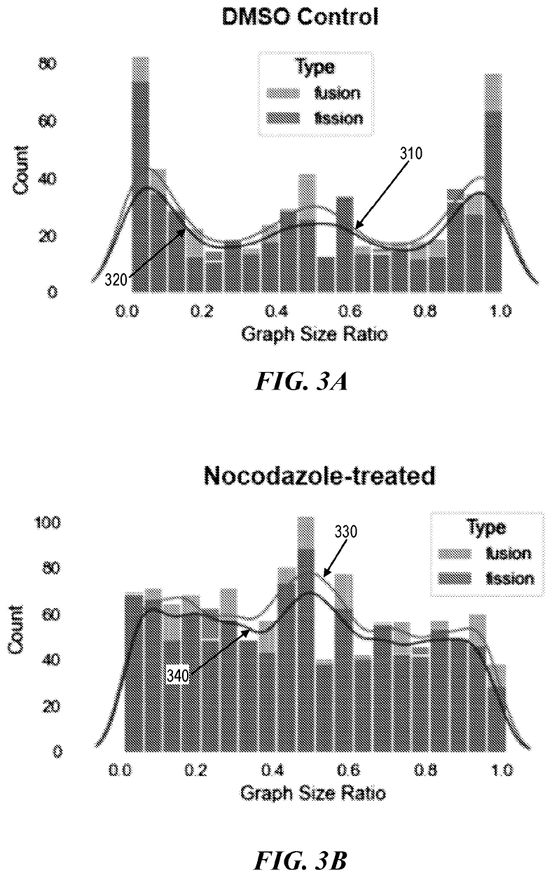

Preliminary results. 4D mitochondrial network tracking and fission/fusion statistics analysis indicate a selection bias in fission and fusion reaction in normal cells, which is not present when cells are treated with nocodazole. FIGS. 3A and 3B show data plots depicting a distribution of graph size ratio for fission/fusion events. Depicted is the normalized mitochondria fragment size immediately after or before fission or fusion events, respectively. Graph size ratio for a particular mitochondria undergoing fission/fusion computed as the size of the mitochondria network normalized by the total size of all mitochondria networks involved. Values close to 0 and 1 correspond to small and large mitochondria relative to the total size. The metric is calculated and plotted for every fragment undergoing detected fission/fusion events. FIGS. 3A and 3B illustrate histogram bars and gaussian-smoothed curves for fission and fusion. The gaussian-smoothed curves 310 and 330 are for fission and the gaussian-smoothed curves 320 and 340 are for fusion. FIG. 3A shows a control cell treated with DMSO and FIG. 3B shows a nocodazole-treated cell with destabilized microtubules.

In DMSO control cells, considerable amount of fission and fusion events are between particularly large and small mitochondria, as evidenced by the high count for graph size ratio near 0 and 1. The nocodazole-treated (microtubule-disrupted) cells show a flatter distribution, indicating fission/fusion reactions happen between more random fragment sizes without strict preferences. These results might point to a distinct selective fission/fusion bias dependent on microtubules.

Item 3: Example Embodiment of Creating a Generative Model of the 4D Mitochondrial Network that Incorporates Mitochondrial Motility, Dynamics, and Functional Response Based on Experimental Data.

Modeling and simulation have been successfully employed to provide system-level insights and predictions in mitochondrial network structure, dynamics and quality control, and diffusive search. One common limitation in these simulations is the lack of realistic spatial context, while mitochondria are actually dynamic tubular networks. Another limitation is the gap between subcellular dynamics and molecular events that needs to be bridged by multi-scale approximations. Some implementations suggest to overcome these limitations by integrating experimental knowledge and constructing a spatial polymer model of mitochondria with biochemical properties.

Rules governing mitochondria structure, motility, and function can be extrapolated from imaging experiments. A meso-scale reaction-diffusion model is used to simulate coarse-grained mitochondria networks. Experimental data will be used to uncover the rules that relate observables (concentrations of chemicals, membrane potential, etc.) to mitochondria morphology and motion. A generative model of the 4D mitochondrial network is capable of reproducing experimental observables, and potentially predicting physiological interventions for mitochondrial disease.

Example Approach. Mitochondrial can be modeled as a random network of particle-based polymers, where particles are connected by harmonic potentials, and undergo random motion. Fission and fusion can be modeled as two separate structural reactions where a bond is formed or broken. The network properties, diffusivity, and reaction rates can be derived from the literature or from experimental data through 4D tracking.

Each particle/node can be viewed as a coarse-grained mitochondria segment associated with multiple spatially-uniform, time-varying node observables. Node observables include membrane potential, concentrations of various metabolites (pyruvate, ATP, ROS, Ca²⁺, etc.) and enzymes, activity of the enzymes, mtDNA mutation level, and mechanical properties. Node observables are subject to constant exchange and equilibration with neighboring nodes. Node observables are also dependent on the overall network topology. Mitochondria quality control can also be modeled by introducing a damage state of mitochondria that corresponds to high mtDNA mutation and ROS level.

Overall, each node observable is a latent function of 1) time, 2) other observables in the same node, as well as 3) observables in nearby connected nodes, and 4) network topology. To uncover the functions that relate distinct chemical species and mitochondria properties, LLSM imaging and diverse fluorescent sensors are used to register the form and activity of the various components. The 4D mitochondria tracking algorithm, which has been discussed in Item 1 to capture the mitochondria dynamics, is used along with other image analysis methods to quantify the other components of the system. At least two methods are explored to decipher the latent function for node observables: 1) maximum likelihood approach for parameter estimation; 2) fuzzy logic method for rule-based interpretation of multivariate relationship.

The simulation can be used to study 1) regulators of energy production, 2) effects of altered selective fission/fusion dynamics on mitochondria quality control, and 3) Ca²⁺ signaling and mitochondrial function. This generative model incorporating mitochondria form, dynamics, and molecular states will be a powerful tool not only for illuminating the basic biology behind mitochondria function, but also for guiding drug discovery with the goal to reverse mitochondrial defects in disease.

Example Outcome. A generative spatial model of the mitochondrial network with predictive power that reproduces experimental observables.

There may have some limitations to deduce correct model parameters from noisy signals limited by imaging conditions. Once all options for improving imaging conditions are exhausted, neural network models can be employed to learn the required complex nonlinear responses and abstract rules.

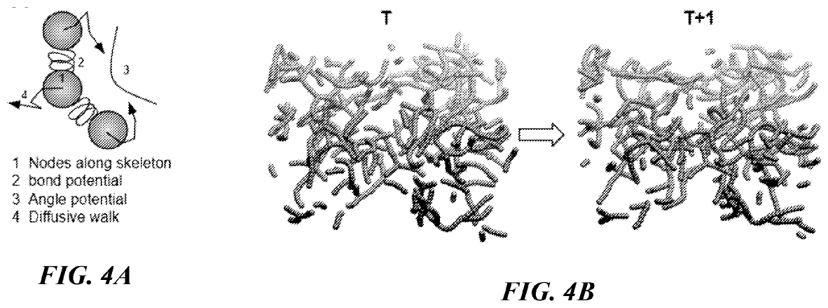

Preliminary results. A particle-based polymer model of mitochondria network (see FIGS. 4A and 4B) is constructed with random topology that reproduces the network statistics, the fission/fusion homeostasis, and mitochondrial motility characteristics resembling the experimental networks.

FIGS. 4A and 4B show a diagram and images depicting an example particle-based simulation for mitochondria motility in accordance with example implementations of the present technology. FIG. 4A shows beads-on-a-string model for mitochondria network. Each node is connected through bond and angle potentials and undergoes Brownian motion. FIG. 4B shows an example simulation illustrating networks of various sizes and topologies undergoing motion over time. This simulation was used as a ground truth to validate the 4D tracking prototype for some example embodiments and implementations described herein.

The disclosed technology presents several new opportunities across many fields, including microscopy, biology, and biotechnology. In some non-limiting embodiments and applications, the disclosed technology is envisioned to significantly advance the study of mitochondria by (1) collecting 4D LLSM imaging data that capture the mitochondrial network for the first time in its true 4D network form, (2) quantifying these 4D mitochondrial network with regards to their motility and fission/fusion characteristics by creating a 4D mitochondria network tracking algorithm, (3) investigating the long standing hypothesis of the existence of selective fusion in mitochondrial quality control, and (4) creating a generative model of the 4D mitochondrial network that complements the newly available experimental data from LLSM imaging experiments. Together, these proposed advances have the potential to greatly influence the basic understanding of mitochondrial biology and in turn to positively impact human health.

### Item 4: Example Embodiment of Tracking Mitochondria in 4D Lattice Light-sheet Data.

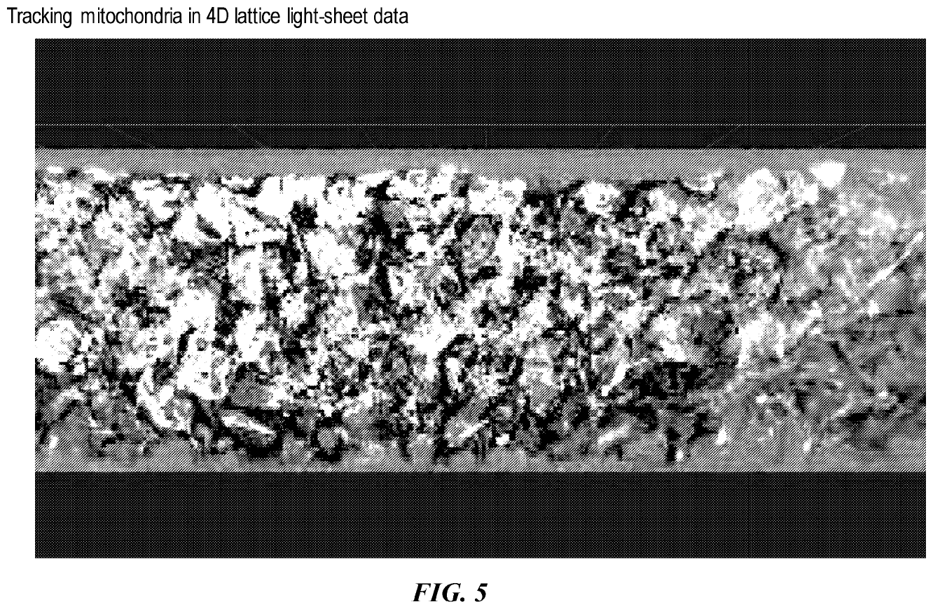

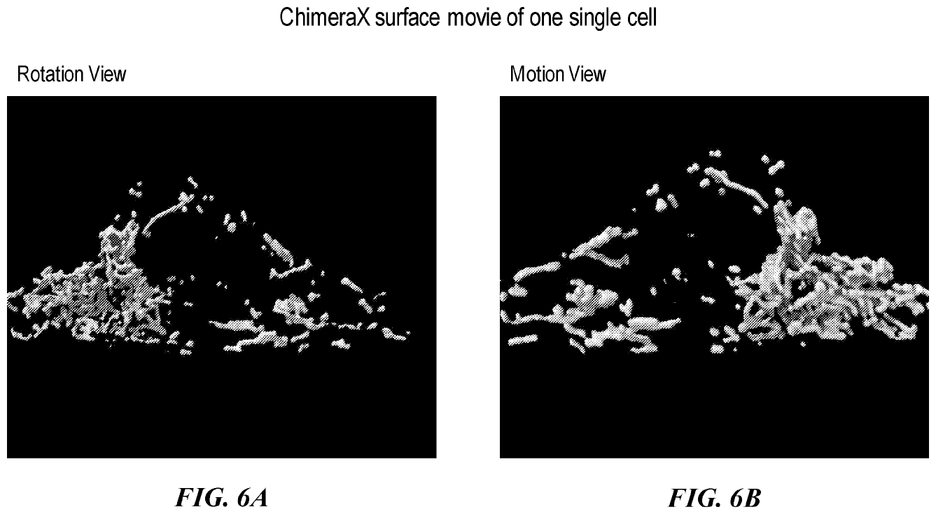

FIG. 5 shows an example of a tracking results in 4D. Tracking Mitochondria in 4D allows to have Mitochondria motion as a readout for cellular states and for drug screening and better understand mitochondria motion. For example, the mitochondria motion can be more understood by studying whether mitochondria visit different locations in the cell to efficiently distribute energy, or/and whether mitochondria constantly make contacts to facilitate fusion and achieve its benefits. In addition, the interplay between mitochondrial motion and fusion and fission events, mito-ER interactions, autophagy, directed transport and other cellular processes can be studied. FIGS. 6A and 6B show examples of a volume rendering of segmented mitochondria of one single cell obtained by a visualization software.

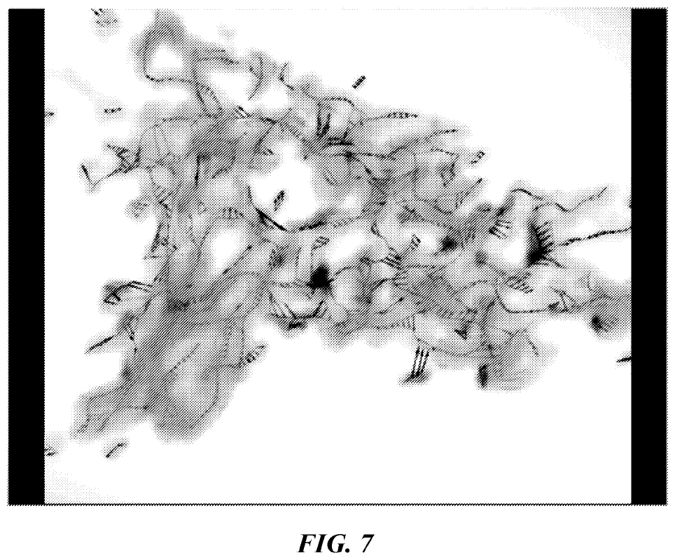

FIG. 7 shows an example of tracking results in 4D of a mitochondrial network similar to FIG. 1D. In FIG. 7, the black lines show the skeleton and linking vectors, the darker shading shows the image at frame t, and the light shading shows the image at frame t+1.

Item 5: Example Embodiment of Synthetic Simulation with Ground Truth to Validate Tracking

In this example, mitochondria networks under motion and topology remodeling are simulated to evaluate the accuracy of tracking. To evaluate the accuracy tracking, mesoscale reaction-diffusion simulation of polymer model of mitochondria can be used. The simulation includes 1) generating network topology close to experimental data, 2) adding diffusion, and 3) adding steady-state fusion and fission reactions.

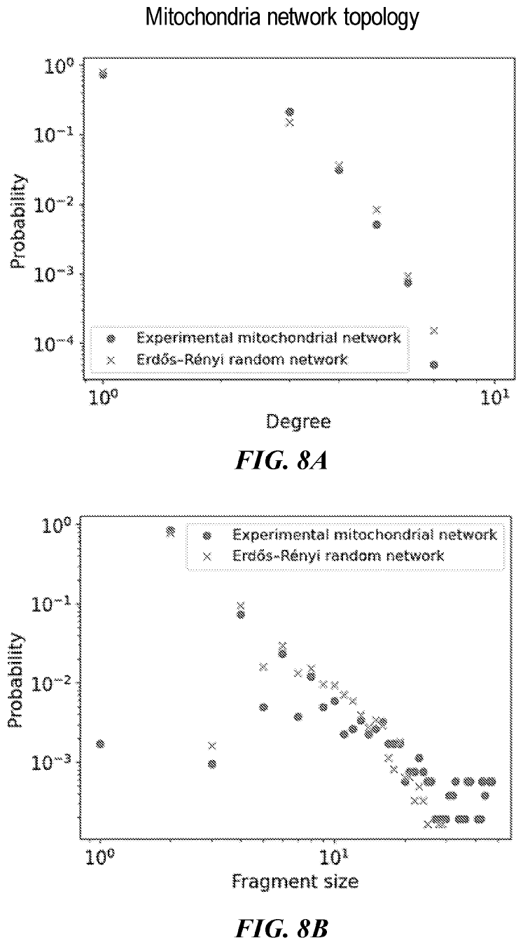

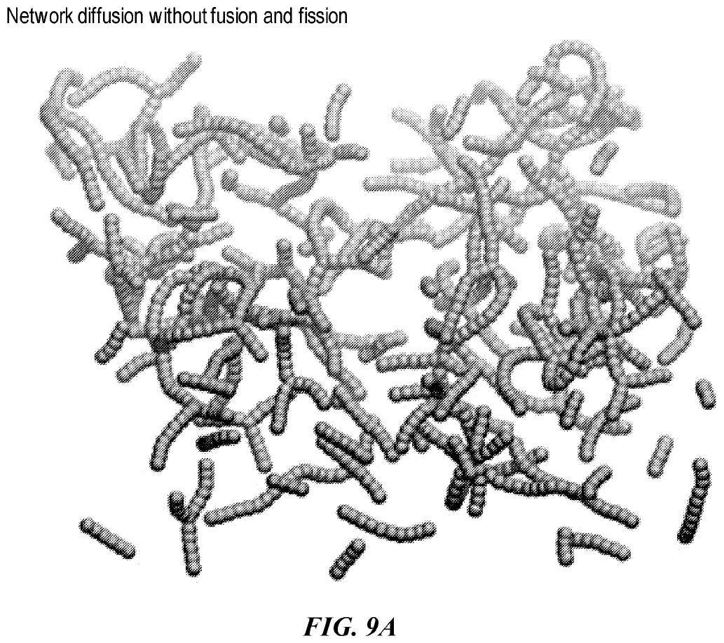

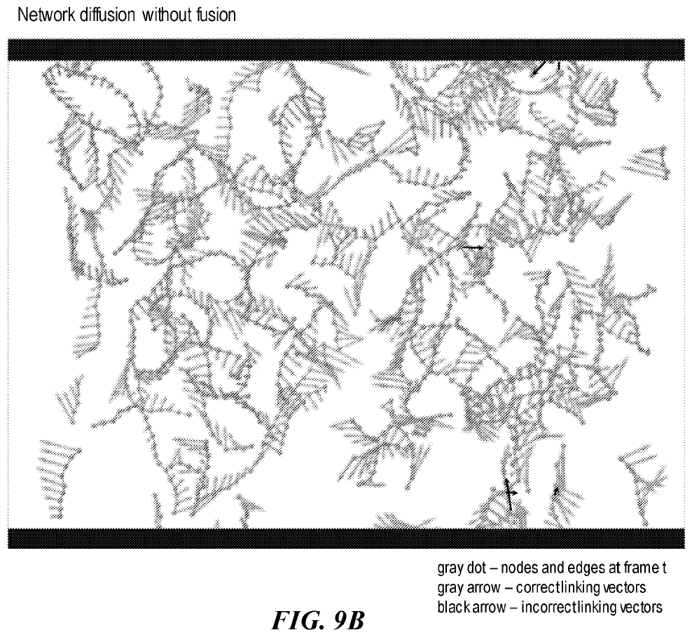

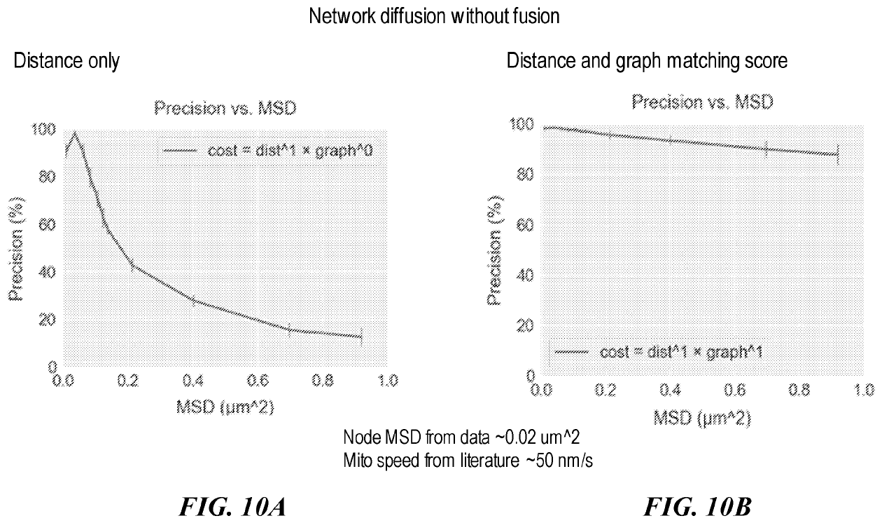

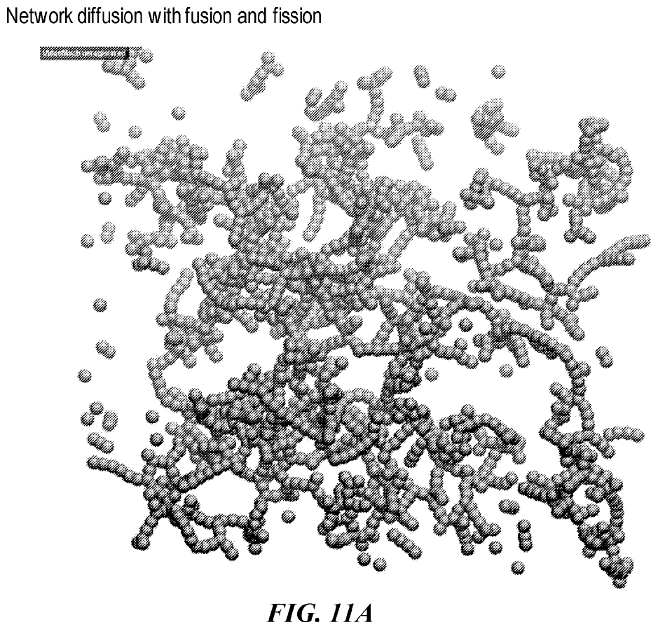

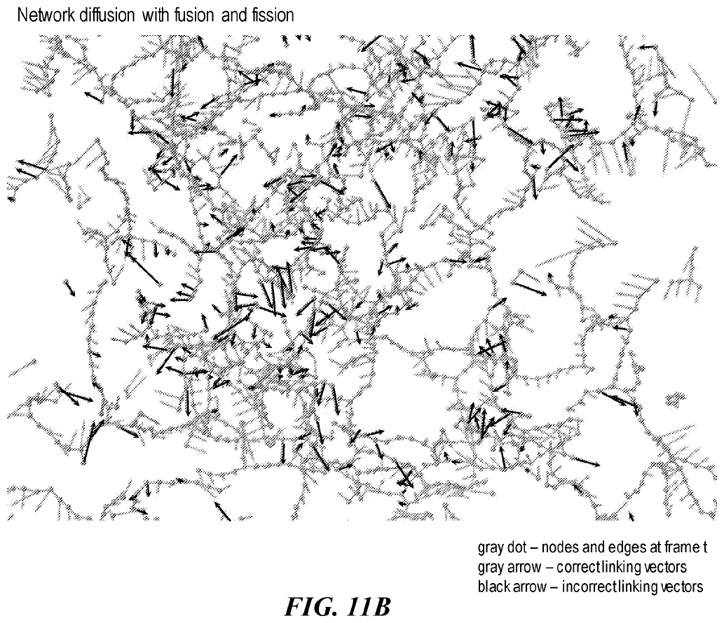

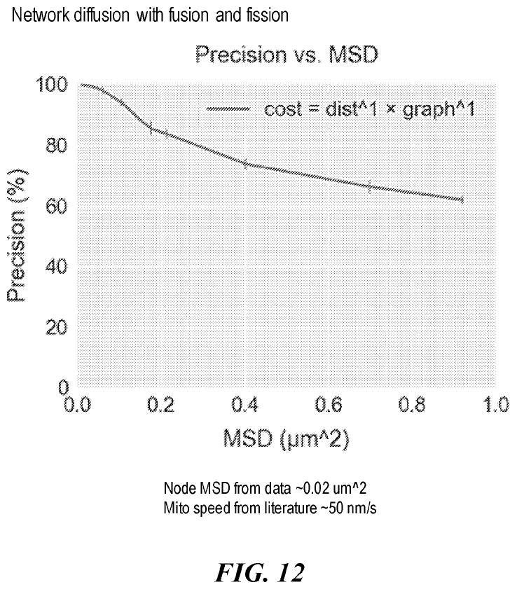

FIGS. 8A and 8B shows experimental and simulated 4D mitochondria network topologies. FIG. 9A shows a realization of a particle simulation (see FIGS. 4A and 4B) for a 4D mitochondrial network according to a topology depicted in FIGS. 8A and 8B where fission and fusion reactions in the network are not included. FIG. 9B shows an example of tracking results on synthetic 4D mitochondria network data as a ground truth to assess the precision and fidelity of the tracking. FIGS. 10A and 10B show examples of graphs showing precision data for a network tracking performance where fission and fusion reactions of the network were left out (i.e. constant graph topology over time). FIG. 11A shows a realization of a particle simulation (see FIGS. 4A, 4B) for a 4D mitochondrial network according to a topology depicted in FIGS. 8A and 8B where fission and fusion reactions in the network are included. FIG. 11B shows an example of tracking results on synthetic 4D mitochondria network data with fission and fusion reactions included as a ground truth to assess the precision and fidelity of the tracking. FIG. 12 shows an example of a graph showing the precision of tracking for a 4D network where fission and fusion reactions are included e.g. the network as shown in FIG. 11A and FIG. 11B.

### Item 6: Example Embodiment of Software MitoTNT Using Mitochondrial Temporal Network Tracking for 4D Live-Cell Fluorescence Microscopy Data

Mitochondria form a network in the cell that rapidly changes through fission, fusion, and motility. This four-dimensional (4D, x, y, z, time) temporal network has only recently been made accessible through advanced imaging methods such as lattice light-sheet microscopy. Quantitative analysis tools for the resulting datasets have been lacking. In this implementation, the techniques for Mitochondrial Temporal Network Tracking in 4D live-cell fluorescence microscopy data are presented. The techniques presented in this implementation are embodied as the software referred to as MitoTNT and mitoTNT uses a spatial proximity and network topology to compute an optimal tracking. Tracking is >90% accurate in dynamic spatial mitochondria simulations and are in agreement with published motility results in vitro. Using MitoTNT, correlated mitochondrial movement patterns, local fission and fusion fingerprints, asymmetric fission and fusion dynamics, and cross-network transport patterns are revealed, and network-level responses to pharmacological manipulations. In the example, MitoTNT is implemented in python with a JupyterLab interface. The extendable and user-friendly design aims at making temporal network tracking accessible to the wider mitochondria community.

Mitochondria are membranous organelles in cells that provide up to 90% of the cellular energy, and are thus fundamental to almost all processes of life from inheriting genetic information to retaining molecular order. In mitochondrial diseases, the function of mitochondria is impacted, leading to diminished energy production and cell and organ dysfunction. This is particularly true in high-energy demand organs such as the muscles, heart, and brain. A vast array of diseases such as metabolic disorders, developmental disabilities4, epilepsy, neurodegenerative disease, cancer, and aging may result from mitochondrial dysfunction. Progress in developing pharmacological modulation of mitochondria has been limited, potentially due to the current difficulty in quantitatively measuring the behavior of the cellular mitochondrial network with sufficient spatial and temporal detail.

Measuring the dynamic mitochondrial network is difficult. Far from the solitary kidney bean shapes depicted in many textbooks, interconnected somatic mitochondrial tubules fill all three spatial dimensions and undergo continuous changes in the fourth dimension of time through active and passive motion, fission, and fusion. Conventional fluorescence microscopy technology has been inadequate to simultaneously capture the full spectrum of both mitochondrial morphology and dynamics in all four dimensions (4D). The advent of high-framerate low-phototoxicity fluorescence microscopes such as lattice light-sheet microscopy (LLSM) has now made the detailed 4D characterization of temporal mitochondrial networks possible, while leaving quantitative analysis of this data still challenging.

The majority of existing quantitative analysis software was designed for two-dimensional (2D) fluorescence images of mitochondria (MyToe14, MitoSPT15, Quo VadoPro 16). For three dimensional (3D) fluorescence images, MitoGraph is a unique tool for the segmentation and quantitation of 3D mitochondrial network morphology, yet lacks temporal analysis. The software packages TrackMate and Mitometer can operate on 4D time-lapse fluorescence microscopy data by performing center-of-mass tracking. However, the abstraction of every mitochondrial fragment as single object poses limitations for accurate sub-fragment level information and network tracking.

The suggested techniques, which are embodied in MitoTNT, the first-in-class software for the tracking of the 4D mitochondrial network, build on the established tools MitoGraph for segmentation and ChimeraX for intuitive visualization. Mitochondria tracking is achieved by solving a linear assignment problem (LAP) that utilizes both spatial and network topology information. Tracking accuracy was validated both in-silico and in-vitro. A reaction-diffusion simulation of the mitochondrial network was created to provide in-silico ground truth for testing. In vitro data of mitochondrial networks was created using LLSM in human induced pluripotent stem cells (hiPSCs). In this implementation, it is demonstrated that MitoTNT's high-resolution mitochondria network tracking is accurate and provides an unprecedented level of detail for mitochondria motility measurement, fission/fusion event detection, and temporal network analysis.

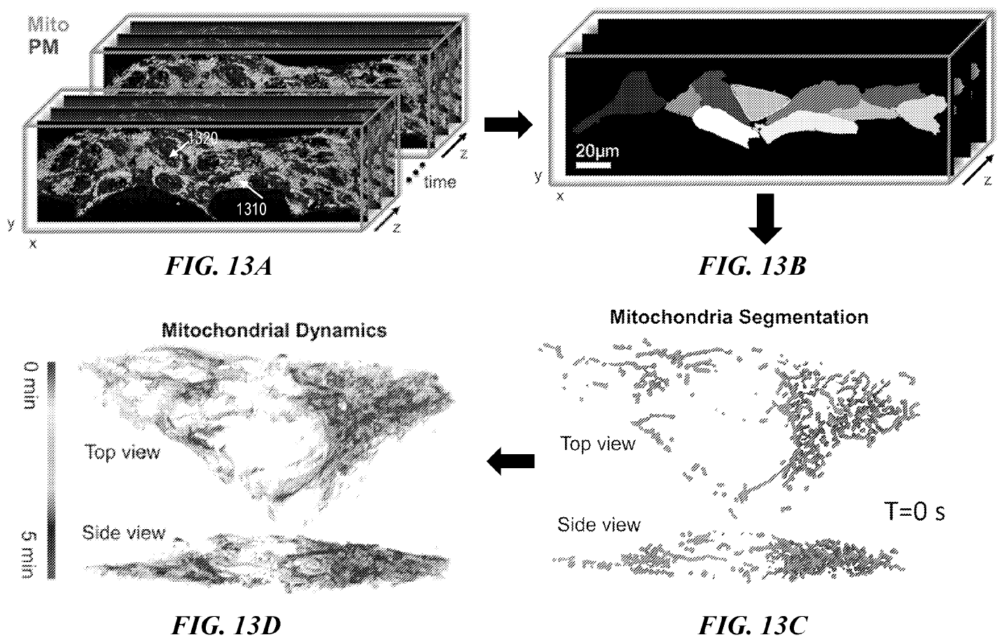

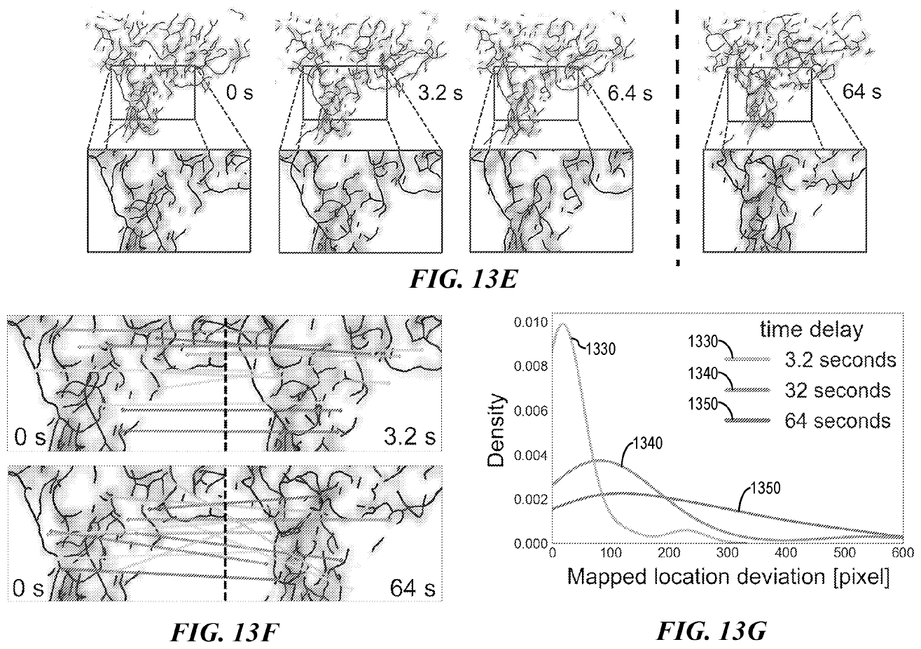

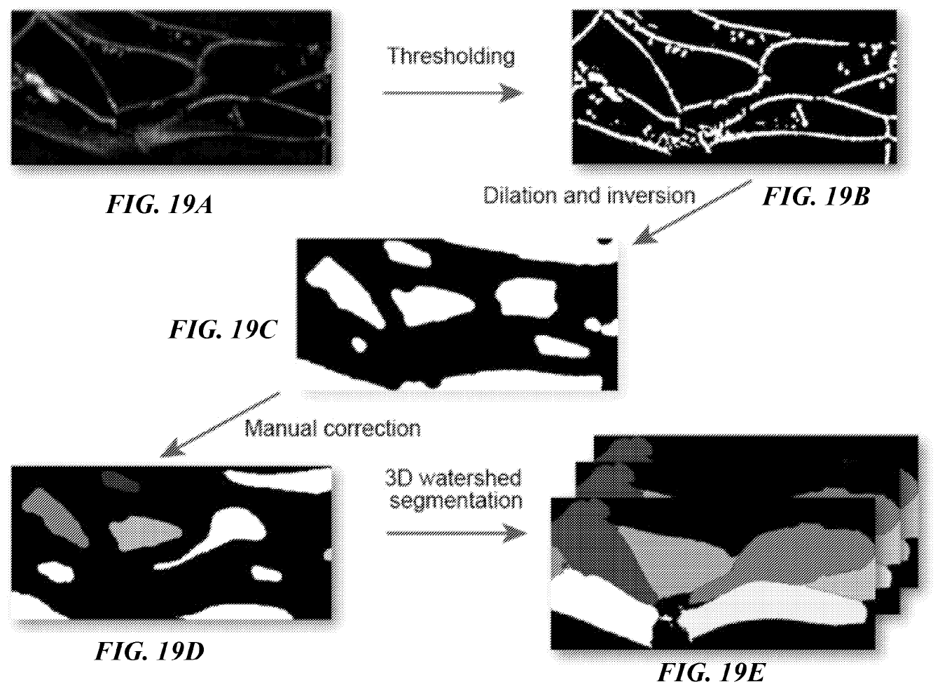

The first aim of the implementation is to confirm that high-framerate fluorescence imaging of the 4D mitochondrial network retains enough information for reliable tracking. The somatic mitochondrial networks of tall cuboid hiPSCs were used as a model system as shown in FIG. 13A and FIGS. 19A to 19E.

FIGS. 19A to 19E show an example of a cell segmentation workflow. FIG. 19A shows a fluorescence signal from CAAX 36 membrane marker in the middle plane. FIG. 19B shows that a cell contour is thresholded. FIG. 19C shows a center of the cell is highlighted through dilation and color inversion of the cell contour. This is used as the seed for watershed segmentation algorithm. FIG. 19D shows that the seed is manually checked and corrected. FIG. 19E shows that the seed for the middle plane is used to segment cell membrane in 3D using the watershed method.

In the example, the cell segmentation for individual stem cells in a stem cell colony is performed as follows. The red fluorescence signal, for example, from CAAX membrane markers, is first normalized and smoothed. Then, the 2D filament filter is used to threshold the membrane contour for the middle z-section. By dilating and inverting the membrane contour, seed labels for the watershed segmentation in scikit-image are automatically obtained. In order to ensure that each cell has a single seed label positioned near the center of the cell body, the seed labels are manually corrected in ImageJ if necessary. Next, the seed labels from the middle z-section was used to perform 3D watershed segmentation on the entire z-stack. The resulting cell segmentation masks are again manually checked, and used to crop single cells. Since the cell movement was found to be minimal on our timescales of 5 minutes per movie, the first frame's segmentation result can be applied to the entire movie.

In the example, the mitochondria segmentation is performed as follows. MitoGraph 3.0 was used for mitochondria segmentation. The input for MitoGraph was the fluorescence signal of individual cells segmented in the previous step along with default parameters. Adaptive thresholding with block size of 10 pixels was used to calculate a block-dependent local threshold. The output of MitoGraph includes the segmented mitochondrial network and the segmented mitochondrial skeleton which includes network edges and network 48 node attributes including 3D coordinates, fluorescence intensity, and tubular width. A custom python script was created to read MitoGraph outputs, construct the full-resolution mitochondrial 50 networks, and compile the networks with node attributes as a python-igraph6 object.

FIG. 13A shows an example of a representative 4D (3D+time) lattice light-sheet microscopy data of a hiPSC colony labeled with MitoTracker (mitochondria is tracked in gray, for example, an area 1310) and expressing CAAX-RFP (plasma membrane shown in black, for example, an area 1320). FIG. 13B shows individual cells in the colony are segmented based on the plasma membrane marker. FIG. 13C shows examples of a top view and a side view where mitochondria fluorescence signal in a single cell is segmented using MitoGraph. FIG. 13D shows an example of a mitochondrial network skeleton dynamics over 5 min every 6.4 s. The different shading shows the mitochondrial network skeleton at different times. FIG. 13E shows that mitochondrial fluorescence density and segmented network skeleton are overlaid and shown for frame numbers 0, 1, 2, 20 at frame interval 3.2 s. FIG. 13F shows scale-invariant feature transform (SIFT) maps image features for two frames separated by 3.2 s (top), and 64 s (bottom). FIG. 13G shows a pixel deviation between SIFT-mapped feature locations at different time intervals 1330, 1340, and 1350.

LLSM was used to acquire imaging volumes at 3.2 s per volume. After deskewing and deconvolution, individual cells were computationally segmented based on the plasma membrane signal as shown in FIG. 13B. MitoGraph was then used to segment the mitochondrial network for consecutive imaging volumes as shown in FIGS. 13C and 13D. At 3.2 s frame interval, it is observed that changes of the 4D mitochondrial network are predominantly limited to small movements and remodeling events while the overall network structure appeared to be conserved from frame to frame as shown in FIG. 13E. This conservation was quantified at several acquisition frame rates by applying the scale-invariant feature transform (SIFT). For small time intervals, SIFT was able to correctly assign network features between frames (see a top figure of FIG. 13F), but failed for longer time intervals (see a bottom figure of FIG. 13F). It is noted that at high volumetric frame rates, mitochondrial network topology is preserved as shown in FIG. 13G. This conserved temporal information is used to achieve 4D mitochondrial network tracking as further discussed below.

### 4D Mitochondrial Network Tracking Using Spatial and Topological Optimization

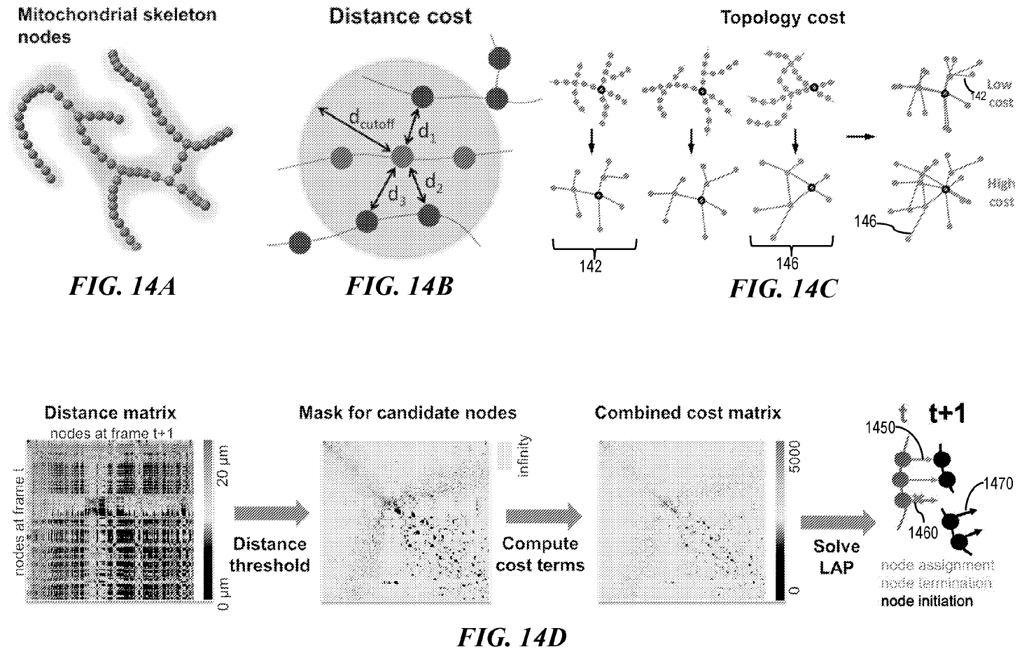

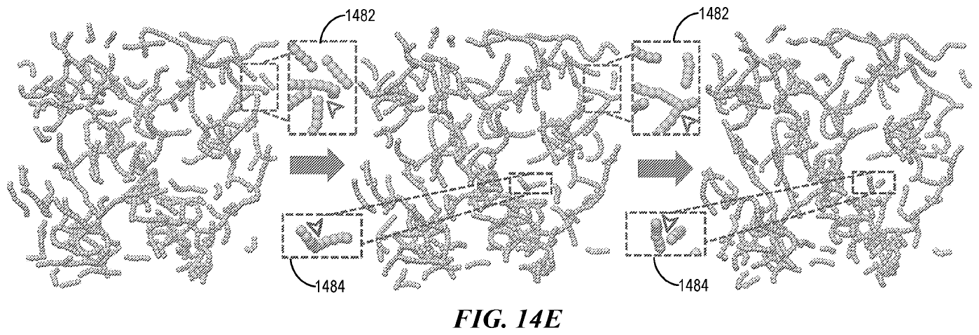

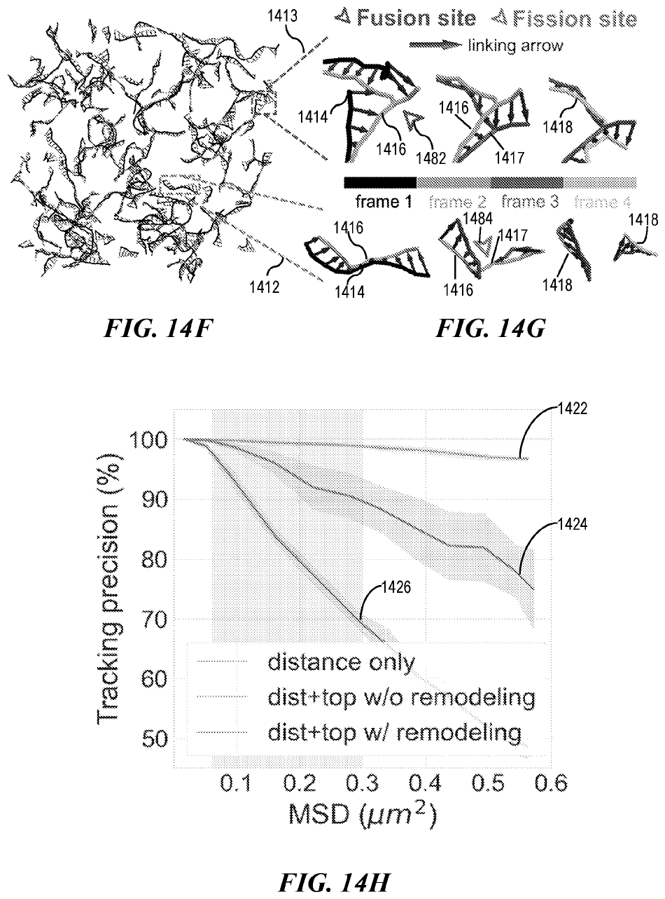

4D mitochondrial temporal network tracking is formulated as an optimization problem that uses information preserved in consecutive frames. Equally spaced nodes were chosen along the mitochondria skeleton as the fundamental units that are tracked as shown in FIG. 14A. FIG. 14A shows discretized nodes along the segmented mitochondria skeleton serve as the basis for network tracking. In FIG. 14A, the cloud indicates a fluorescence density, the cylinder indicates a segmented skeleton, and the sphere indicates a skeleton node. FIGS. 14B and 14C illustrate cost terms used for the linear assignment problem (LAP) formulation of node tracking. Spatial proximity is measured as distances between nodes within two consecutive frames. Topology cost is computed using a graph comparison that assigns low cost 142 for similar local topology. The high cost 146 is indicated. FIG. 14D shows LAP formulation of node tracking for the mitochondrial network. FIG. 14D illustrates, from left to right: 1) pairwise distance matrix for nodes at frames T and T+1; 2) thresholds to eliminate nodes too far to be tracked; 3) spatial separation and network topology constraints; 4) the solution to the LAP yields the tracking results as linked node pairs, along with terminated and initiated nodes. FIG. 14E shows three consecutive frames of a reaction-diffusion mitochondrial network simulation with a representative fusion event 1482 and a representative fission event 1484. FIG. 14F shows temporal network tracking for the simulated mitochondria for two consecutive timepoints at frame and frame 2. The arrows indicate the node tracking between the two frames. FIG. 14G shows magnification of example in-silico fusion 1413 (see the triangle 1482) and fission 1412 (see the triangle 1484) events in FIG. 14F. In FIG. 14G, the frames 1 to 4 are indicated as 1414, 1416, 1417, and 1418. FIG. 14H shows an accuracy of in-silico tracking compared to node mean squared displacement (MSD), N=10 simulations. MSD relates to frame as MSD=6Dτ. Commonly achievable frame rates with LLSM highlighted in shade.

Such a discretization of the mitochondrial network can be automatically calculated using the software MitoGraph. In the observation, it is found that spatial proximity as shown in FIG. 14B and network topology as shown in FIG. 14C are conserved characteristics that likely allow temporal tracking. At high frame rates, mitochondrial motion is limited, and the nodes located close to the current position in the next frame tend to be the correct candidates. However, this distance metric quickly decorrelates in dense network regions. Similarly, the mitochondrial network topology remains relatively stable at high framerates and only decorrelates at high fission/fusion rates of the network. A topological dissimilarity score is developed to capture this parameter. The score is computed using a fast alignment-based graph comparison method (see “Efficient graph comparison using an alignment-based method”) to measure how different the network topologies around any two candidate nodes are. Nodes embedded in a similar local network topology are more likely to be linked in time.

Similar to established particle/object tracking methods, the network tracking problem was formulated as a linear assignment problem (LAP) that solves for the optimal node assignment through constraints as shown in FIG. 14D. First, the distances between nodes in two consecutive frames, T, T+1, were computed as a pairwise distance matrix. Next, local distance thresholds were estimated for each node at frame T (see “formulated as a linear assignment problem for node assignment”).

Nodes located within these thresholds at frame T+1 were considered candidate nodes while those beyond were ignored. Then, network topology was incorporated using the topological dissimilarity score for each candidate node pair (node at T and candidate node at T+1). The distance and topology costs were then combined with equal weights. Mitochondrial dynamics and imaging artifacts often contribute to fluctuations in the number of skeleton nodes. To account for this fluctuation, additional constraints were added to the final cost matrix (see “Network tracking formulated as a linear assignment problem for node assignment”), thereby permitting three options for a temporal assignment: 1) link two nodes between frames (see 1450 in FIG. 14D), 2) terminate a node in the current frame (see 1460 in FIG. 14D), or 3) initiate a new node in the next frame (see 1470 in FIG. 14D). Finally, the frame-to-frame tracking result is given as the optimal node assignment to the LAP by minimizing the global sum of the final cost matrix. Gap closing is performed at the end of frame-to-frame tracking in order to connect prematurely terminated node tracks, using the same cost terms (see “Gap closing”).

### Network Tracking Formulated as a Linear Assignment Problem for Node Assignment.

To track nodes at frames T and T+1, the node coordinates are used to calculate a pairwise distance matrix where element at row, m, and column, n, equals the distance between node m at frame T and node n at frame T+1. To limit nodes under consideration for a temporal link, a threshold is implemented. The user can specify the threshold as the distance to the N-th closest neighbor for each node. Additionally, the user can input the maximum node speed, such that nodes located beyond maximum node speed*frame interval are not considered for linking In the example, it is found that the distance to 10th nearest neighbor is sufficient for tracking at relatively high framerate. The graph comparison score (topology cost) is then computed for the candidate node pairs. The combined cost matrix is the product of distance and topology cost matrices, whose weight can be adjusted by the exponents. Equal weighting with exponents that are both equal to 1 were used. The self-assignment matrices with alternative cost equal to 98th percentile of all previous assignment cost (2*the minimum of all potential costs for the first frame) was then added. The auxiliary matrix is filled with blocking values. The exact definition of self-assignment matrices and auxiliary matrix can be found in the U-track paper. The final cost matrix is then solved using the Jonker-Volgenant algorithm. The tracks of network nodes are then stored and dynamically updated during frame-to-frame tracking.

### Efficient Graph Comparison Using an Alignment-Based Method

The topological dissimilarity cost term compares the local network topologies between the nodes from two frames. This is an inexact graph matching problem with partial node-correspondence since only the two nodes for which the cost is to be computed, termed the target nodes, are known. Existing methods including graphlet-based methods, alignment-based methods, spectral methods, and recent portrait divergence methods are usually designed for large complex networks, computationally non-trivial and application specific. Mitochondrial networks usually have much less convoluted connectivity, and thus a small network neighborhood is usually sufficient for our tracking purposes. The proposed graph comparison algorithm needs to prioritize computational efficiency to accommodate the many iterations over network nodes and timepoints for large LLSM dataset. Thus, a heuristics-driven, alignment-based method that maps the nodes in two subnetworks is designed, and the topological dissimilarity score is computed as the norm of the differences between two mapped adjacency matrices.

Two types of networks are defined: 1) the classic networks consisting of terminal (degree=1) and branching (degree>2) nodes; 2) the full-resolution networks which include additional bulk nodes (degree=2), equally spaced along the skeleton. The network tracking is approached by tracking the all the nodes in the full-resolution networks. The network tracking problem is formulated as a linear assignment problem (LAP) for node assignments under certain spatial and topological constraints.

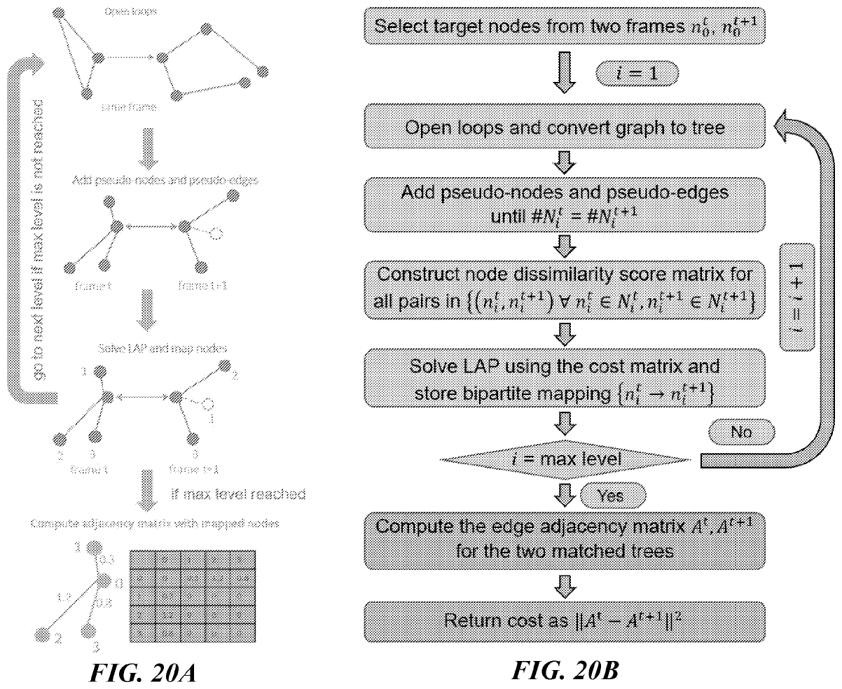

First, in order to efficiently compare the overall network topology around the target nodes, two selected full-resolution networks are converted to the classic networks by eliminating the bulk nodes and directly connecting the terminal and branching nodes. Second, subgraphs up to a user defined maximum k-level from the target nodes are used, where the k-th level refers to all the nodes whose shortest path to the target nodes have k nodes. For the subgraphs, breadth-first operations starting from the target nodes are performed to 1) convert the graphs to trees by opening loops, and 2) add pseudo-nodes and pseudo-edges of weight zero to ensure that the numbers of nodes at each level are the same. Third, a node dissimilarity score between node pairs is defined, and this score is used as the cost in the LAP to solve for the optimal node mapping at a given level. This step iterates for each level until the maximum level is reached. Now that the graph alignment is complete, the topological dissimilarity score between the target nodes can be given as the Euclidean norm of the differences between the two adjacency matrices with distance weights. FIGS. 20A and 20B illustrate the graph comparison algorithm at the center of the topology score calculation. FIG. 20A shows a visual illustration for the alignment-based graph comparison algorithm and FIG. 20B shows a detailed pseudo-code for the algorithm.

LAP-based techniques have existed for a long time to solve tracking problems, but they fail in a network-based setting such as in organelle networks in a cell. In the implementations, the topology cost is created, which allows to take the overall network structure into account between consecutive frames. With the topology cost applied to the tracking algorithm, the required tracking accuracies for organelle networks is accomplished unlike the conventional technologies that could never reached the same tracking accuracies (compare FIG. 10A (only distance LAP), and FIG. 10B distance and topology score LAP).

### Gap Closing

Once frame-to-frame node tracking is complete, node tracks with frames more than min_track_size are qualified for gap closing. The distance and metric costs are computed between the last frame in track A (frame_{end}^{A}) and the first frame in track B (frameₛₜₐᵣₜ^{B}) if both of the following criteria were met:

1<gap size<max_gap_size, where gap size=frameₛₜₐᵣₜ^{B}−frame_{end}^{A}, distance<gap size*9*variance (combined track displacements). Because the total number of tracks can be large (more than 10,000), the cost matrix for all tracks can be memory-consuming, and solving the LAP of such a matrix can be computationally expensive. To solve this problem, the full cost matrix is divided into overlapping blocks to obtain sub-optimal global assignment. First, the tracks are sorted based on the start frame so that short tracks that can be linked are positioned relatively close. Next, a N×N block is cropped at the top left diagonal of the full cost matrix, where N=max_gap_size*average # of tracks per frame, and use this matrix to close gaps for the tracks involved. Finally, this block 0.8*N tracks are moved down the diagonal, to allow gap closing for tracks at the boundary. This process repeats until the full cost matrix is traversed. This iterative gap closing scheme improves memory and computation performance without noticeably changing the number of closed tracks.

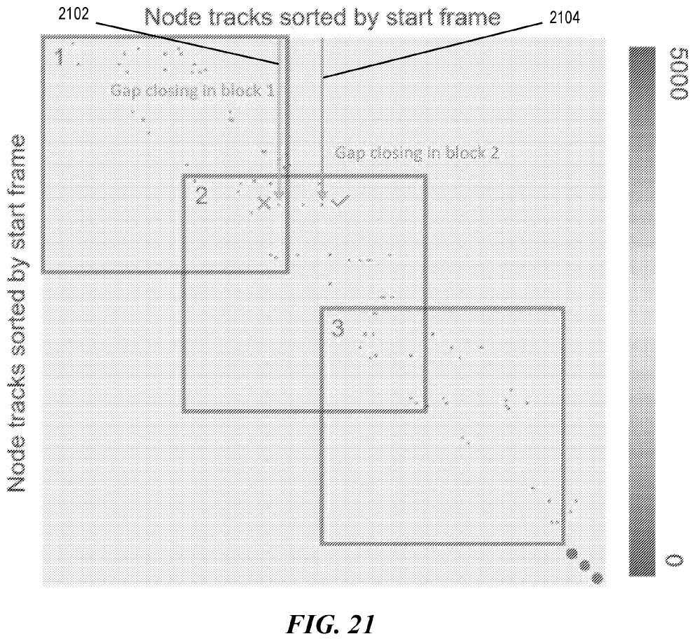

FIG. 21 shows a diagram illustrating a memory-efficient gap closing scheme using overlapping cost matrix blocks. An illustrative gap closing matrix is shown. Row and column indices are node track IDs ranked by the track start frame number. The cost terms are calculated as the product of the distance and topology costs for the end node of the row track, and the start node of the column track. Thus, no assignments are allowed for the lower triangle. Because the number of tracks can be very large, overlapping blocks of the cost matrix are used for track assignments to reduce memory usage and speed up computation. Two track assignments for a track in the overlapped region between two blocks are shown. Because the track is on the edge of the block, the assignment from block 1 has high cost and is sub-optimal (see 2102). However, because the block includes more potential tracks, the assignment from block 2 gives the optimal track assignment (see 2104).

### In-Silico Validation of MitoTNT Through Spatial Reaction Diffusion Simulations of Mitochondrial Networks

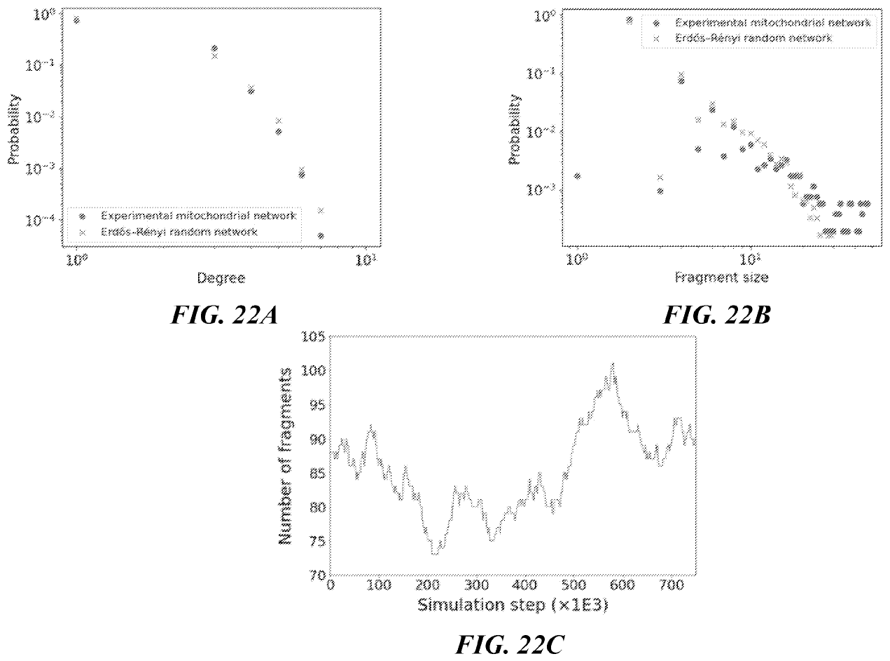

The next aim was to validate the suggested tracking algorithm using synthetic data as ground-truth. A meso-scale reaction-diffusion simulation was developed to model temporal mitochondrial networks as shown in FIG. 14E. For the simulation, the ReaDDy framework was used to model mitochondria as connected mitochondrial skeleton particles that were held together by bond, angle, and repulsion potentials. Mitochondrial motion was assumed to be diffusive only. The spatial distribution and density of the in-silico mitochondrial network was modeled after in-vitro imaged mitochondrial networks found to resemble a mixture of Erdös-Rényi random networks (see FIGS. 22A and 22B).

FIGS. 22A and 22B show examples of network metrics for the mitochondrial simulation. FIG. 22A and FIG. 22B show the degree distribution and the fragment size distribution, respectively, for the experimental network segmented by MitoGraph (dot), and the random network generated for simulation (cross). FIG. 22C shows the total number of fragments in the simulation is monitored as a function of simulation timestep.

Fission and fusion were included as structural reactions such that fission reactions remove a bond between skeleton nodes and fusion reactions create a bond between unbound skeleton nodes. Experimental observations of fission and fusion rates were adjusted through iterative sampling of fission and fusion reaction rates (see “Gap closing” above).

Tracking accuracy of the algorithm as presented in the implementations was subsequently tested using this simulation as ground-truth. It is found that each fragment of the mitochondrial network, as well as fission and fusion events, are tracked faithfully with few mis-assignments as shown in FIGS. 14F and 14G. Itis found that the distance constraint alone results in relatively poor tracking performance as shown in FIG. 14H (see curve 1426) likely due to ambiguous assignments in the dense mitochondrial network. In contrast, when paired with the topology constraint, consistently reliable tracking was achieved with fission and fusion switched off (95-100% accuracy, curve 1422 in FIG. 14H) or on (>90% accuracy, curve 1424 in FIG. 14H) in the regime relevant for LLSM (shaded region, see “Reaction-diffusion simulation of spatial mitochondrial networks”)).

### Reaction-Diffusion Simulation of Spatial Mitochondrial Networks

The particle-based reaction-diffusion simulation tool ReaDDy was used to create a synthetic ground truth dataset of 4D mitochondrial dynamics. A rectangular box potential was set up to represent a cell with dimensions of x, y, z=20, 20, 5 microns with x, y, z=2000, 2000, 500 units, where each simulation spatial unit equals 10 nm. A harmonic boundary potential was added with force constant kbox=100. Mitochondrial skeleton nodes are represented as individual particles in this box. To form interconnected chains of such particles to represent the mitochondrial network, each node is modeled by the spherical repulsion potential with equilibrium diameter of 350 nm, reflecting real-world mitochondrial tubular width. Between each connected node there is a bond potential with k_{bond}=1, an angle potential with k_{angle}=10, and equilibrium angle=180 degrees. All potentials are harmonic.

To generate the initial classic networks, multiple smaller random networks are combined. For each random network partition, n=60 network nodes are randomly connected with mean degree p=1.0, and any unconnected nodes are removed. More networks are created until the total number of nodes N=300. To convert the classic networks into the full-resolution networks in space, the position is randomly assigned for one node in the network, and traversing the entire network starts, starting from that node. Each edge in the classic networks is replaced by 2-5 bulk nodes. Fission events are modeled by removing a bond potential between connected nodes and fusion reactions are modeled by event is modeled by topology dissociation reactions. For each connected component, a random edge is deleted at a probability proportional to the total number of edges.

The separated components again can undergo fission events, until there are fewer than four nodes to avoid unrealistically small fragments. Fusion event is modeled by spatial topology association reactions. There exists certain probability of bond formation when any two nodes are located within two times the node diameter. We designed an iterative simulation scheme to obtain simulations with balanced fission and fusion. First, the system is relaxed and equilibrated for 106 steps without fission/fusion events. Next, initial guesses for the remodeling rates are used to simulate fission/fusion for 2×10⁵ steps. The fission/fusion rates are then updated to compensate for the changes in average fragment size. This cycle is repeated until the changes in average fragment size is small. Lastly, the simulation is re-initiated using the fission/fusion rates established from the latest stable simulation, and the fission/fusion rates is adjusted every 2×10⁵ steps to compensate any deviation from steady-state dynamics.

To compute the range of MSD accessible to the experimental setup, we used an upper bound of 0.01 μm²/s for node diffusivity D based on the literature and our data, and frame delay t ranging from 1 second to 5 second for LLSM. Thus, using MSD=6Dτ, the experimentally relevant MSD is 0.06-0.3 μm²/s.

### In-Vitro Validation and Evaluation of 4D Mitochondrial Network Tracking

Next, the tracking algorithm on LLSM data of 4D mitochondrial networks in cultured cells were validated. CAAX-RFP hiPSC colonies were labeled with Mito Tracker Green and imaged at 3.2 seconds per volumetric frame for a duration of 5 minutes.

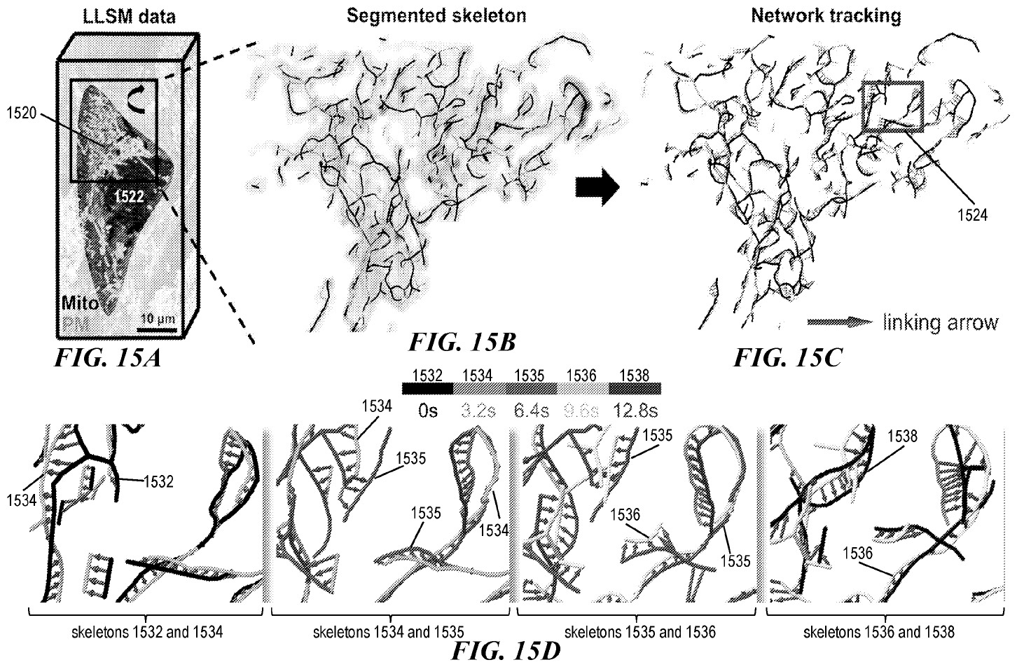

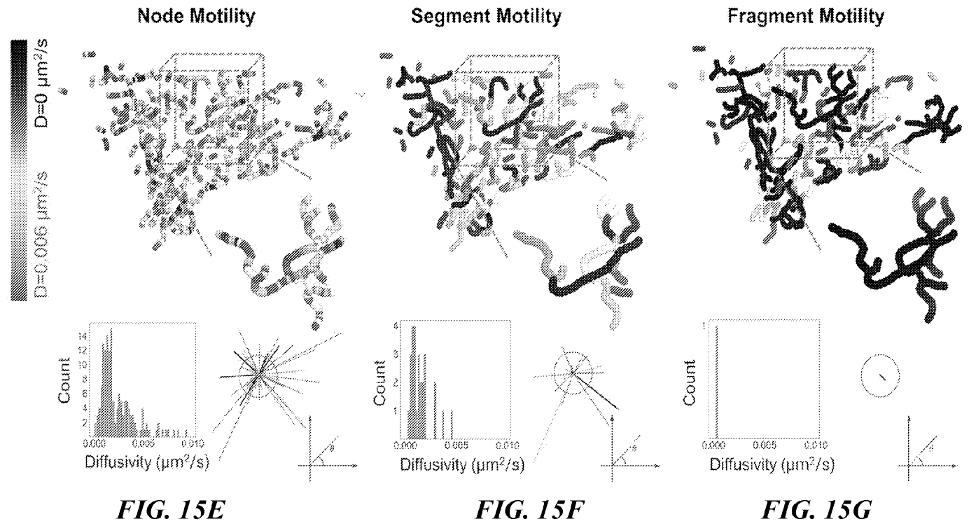

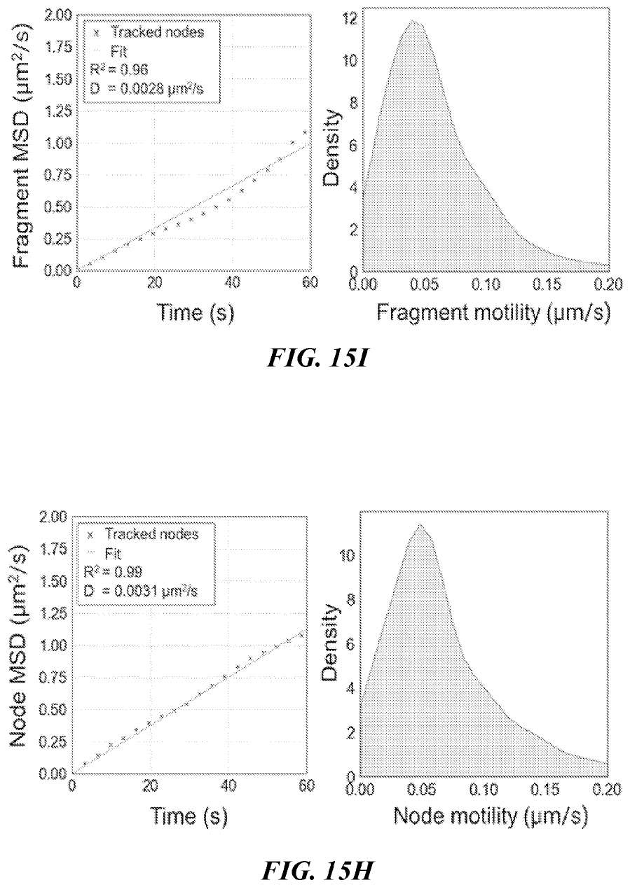

FIG. 15A shows LLSM volumetric snapshot of a segmented cell. The different shadings show mitochondrial network 1520 and plasma membrane 1522, respectively. FIG. 15B shows zoom-in on the mitochondrial network in FIG. 15A. Fluorescence signal and segmented network skeleton are overlaid for two consecutive frames, one frame at 0 s and another frame at 3.2 s. The representative region 1524 is indicated in FIG. 15C, which shows tracking of the network nodes for the two frames shown in FIG. 15B as visualized by arrows. FIG. 15D shows a zoom-in to a representative region 1524 in FIG. 15C tracked over 12.8 s. The skeletons 1532, 1534, 1535, 1536, and 1538 in different shadings indicate in the order of time and correspond to 0 s, 3.2 s, 6.4 s, 9.6 s, and 12.8 s. In FIGS. 15E to 15G. the top view shows mitochondrial nodes are shown in different shadings for diffusivity at node, segment, or fragment levels from high (lighter) to low (thicker) diffusivity. In FIGS. 15E to 15G, the distribution of diffusivity values is shown in the bottom left and linking vectors compared to a fixed reference vector are shown in the bottom right. FIGS. 15H to 15I show MSD curve and motility distribution for nodes and fragments, respectively.

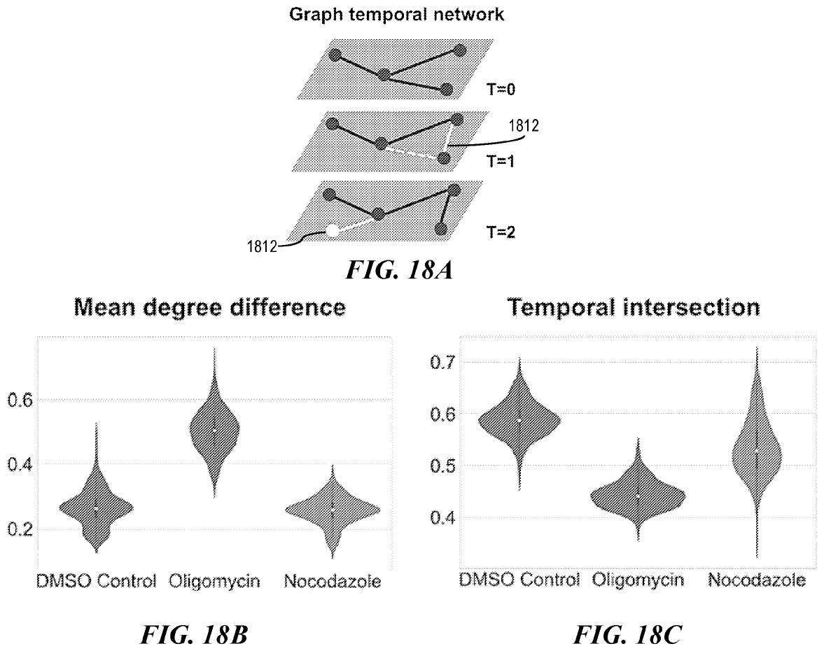

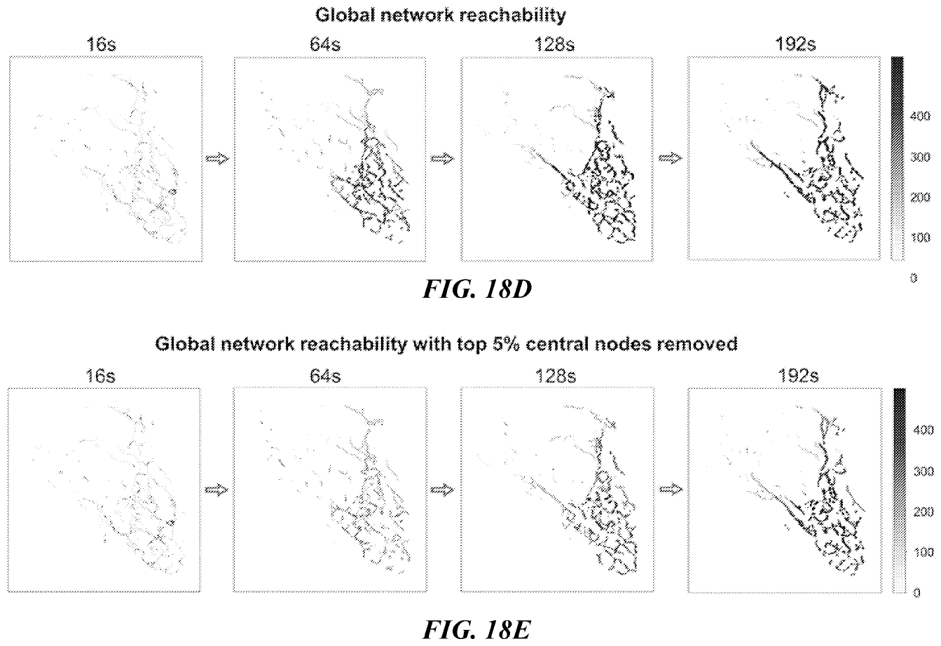

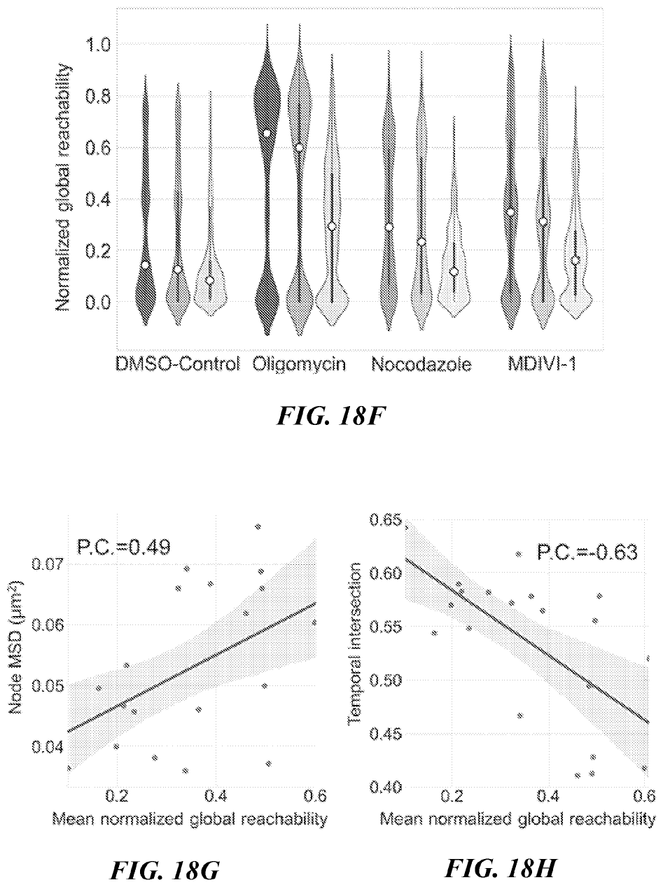

Cells and mitochondrial network were segmented as shown in FIGS. 15A and 15B and MitoTNT used to track the network as shown in FIG. 15C. Careful examination of the tracking results showed that the mitochondrial network skeleton is faithfully tracked over time as shown in FIG. 15D. Depending on the level of granularity required for the biological question of interest, tracks for the nodes as shown in FIG. 15E that belong to the same segment as shown in FIG. 15F, or the same fragment as shown in FIG. 15G can be obtained. Itis found that somatic mitochondrial motility is diffusive not only on the fragment-level but also on the mitochondrial skeleton node-level as shown in FIGS. 15H, 15I. It is observed that the high-resolution tracking on the level of mitochondrial skeleton nodes illustrates that mitochondrial motility and dynamics exhibit complex spatial and temporal details and a heterogeneity in speed and orientation (FIGS. 15E to 15G, lower panel). Finally, the high-resolution tracking results was compared to previously published values of lower-resolution center-of-mass tracking. It is found that the average mitochondrial network fragment motility for hiPSC mitochondria (0.06±0.03 μm/s) is in good agreement with motility data from 3D spheroids (0.03 μm/s) and 2D adherent cells (0.08 μm/s) as shown in FIGS. 18A to 18H.

### Network Mobility Measurements

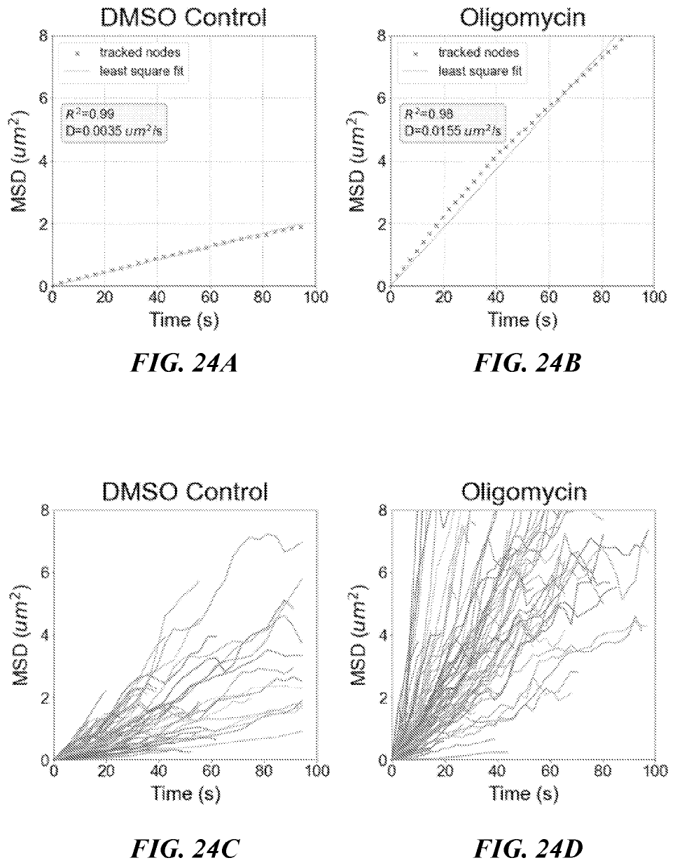

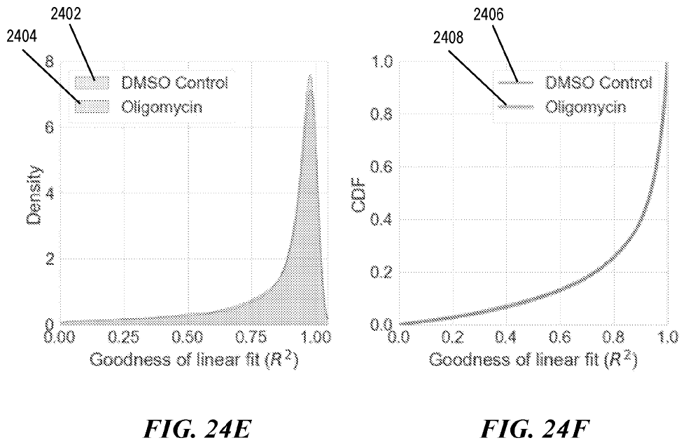

To measure the network motility of the mitochondrial network, mean-square-displacements (MSDs) vs. time delay curves are computed following previous works. The node ensemble averaged MSDs are plotted for control and oligomycin (See FIGS. 24A and 24B). The MSDs for single tracks are plotted for control and oligomycin (See FIGS. 24C and 24D). Around 80% of the nodes have a coefficient of determination for linear fit greater than 0.8 (see FIG. 15F). To map diffusivity onto mitochondrial nodes, the network nodes are firstly chosen at a center frame. Next, the node track coordinates 10 frames before and 10 frames after the center frame are collected. In a last step, the MSDs are computed at various time delays in this time window to determine the diffusivity of each node.

To compute vector correlation, the displacement vector is firstly obtained for a selected node at a selected frame. Next, the vector correlation is computed, as well as the vectors for the selected node at timepoints 1 frame before and after the selected frame. The vector correlation is computed between this vector and vectors for the nodes directly connected to it and given by the dot product of two vectors, divided by the square of the norm of the longer vector. The final correlation value for the selected node at the selected time is reported as the average of these two values.

FIGS. 24A to 24F show simulation results that mitochondrial skeleton node diffusivity predominantly follows normal diffusive motion. FIGS. 24A and 24B show node-averaged mean square displacement (MSD), which is computed with respect to time delays for two conditions, DMSO control in FIG. 24A, and oligomycin in FIG. 24B. The linear fit line is shown together with the coefficient of determination (R²) and diffusion coefficient (D). FIGS. 24C and 24D show node-averaged MSD for DMSO and oligomycin. FIGS. 24E and 24F show the goodness of linear fit as measured by R² is plotted as density distribution (see FIG. 24E), and cumulative distribution function (CDF) (see FIG. 24F). R² close to 1 indicates the data points follow a linear pattern. In FIGS. 24E and 24F, the DMSO control 2402 and oligomycin 2404 are used.

### High-Resolution Mitochondria Tracking Reveals Heterogeneous Sub-Fragment Motility and Correlated Movement Patterns

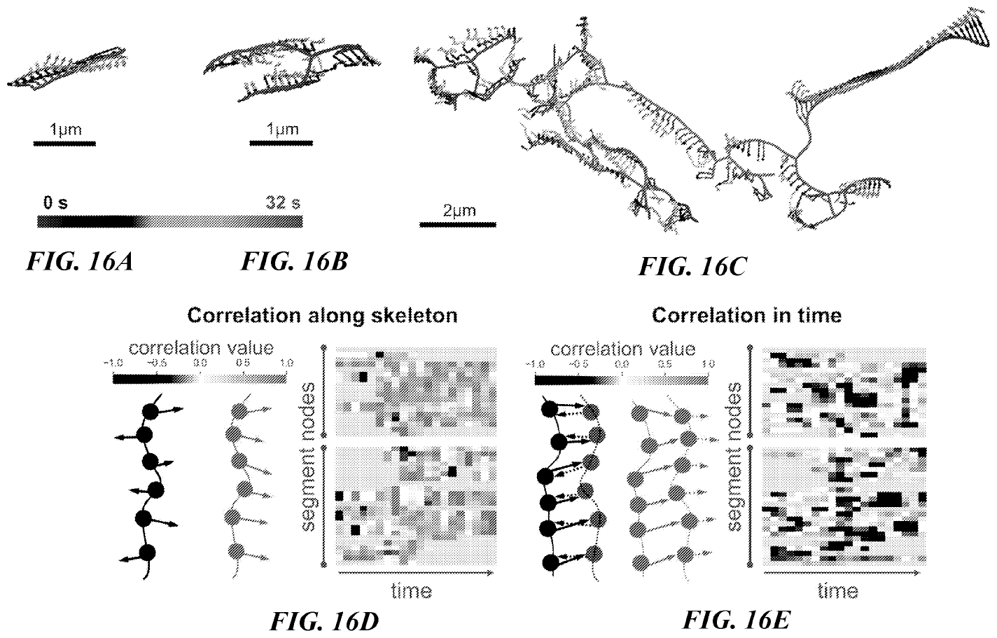

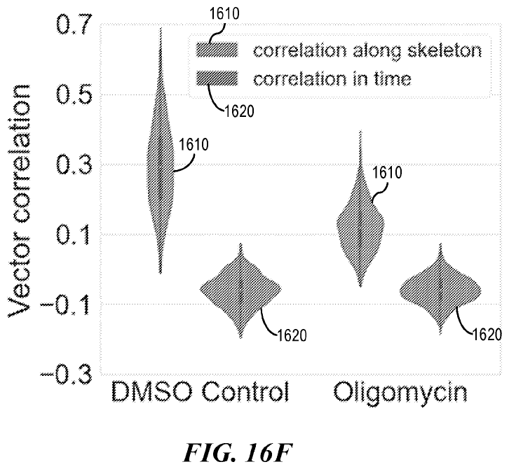

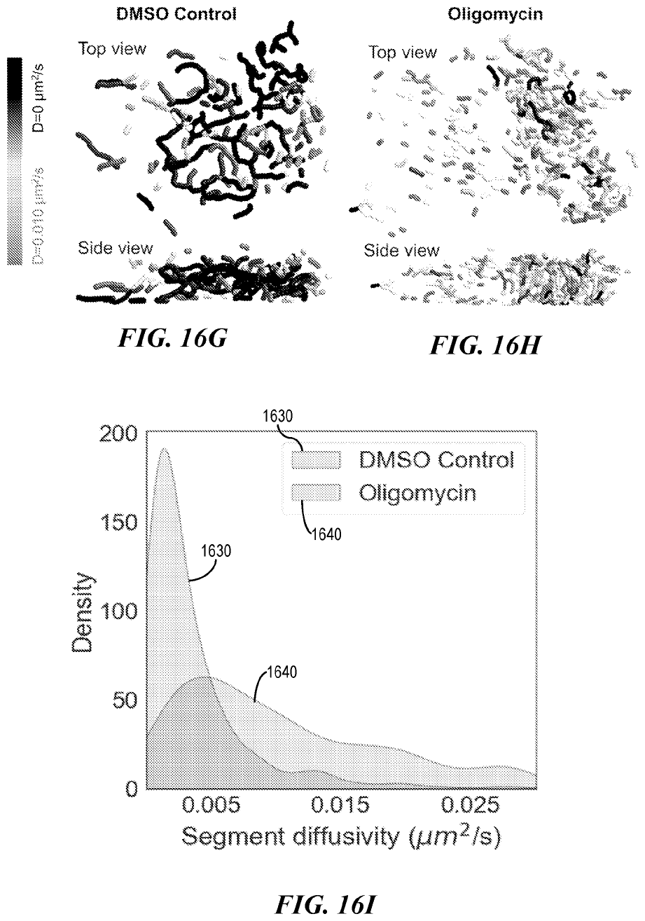

Individual fragments displaying a wide range of movement patterns were observed, which include translational, and rotational components. Branches of the same mitochondrial fragment can simultaneously undergo motions with different orientations and modes. Here, three examples are showcased: 1) a small fragment exhibiting twisting motion as shown in FIG. 16A, 2) a medium-sized fragment exhibiting concentric inward motion as shown in FIG. 16B, and 3) a large fragment exhibiting convolution of different motility patterns as shown in FIG. 16C.

To further investigate network branch motility, tracking vectors correlated between adjacent nodes on the same segment, and between the same node at consecutive frames. It is observed that spatial correlation along the segment skeleton is predominantly positive as shown in FIG. 16D, which demonstrates a concerted motion. In contrast, temporal correlation between frames is predominantly zero (random motion) to slightly negative (oscillating motion), while interspersed with short period of positive values (directional motion) as shown in FIG. 16E. This data confirms that mitochondrial branches move as a unit, but in a relatively random manner (FIG. 16F, control). In FIG. 16F, the correlation along skeleton 1610 and the correlation in time 1620 are shown. The ATP synthase inhibitor oligomycin that induces mitochondrial fragmentation was employed to investigate if motion correlation findings are dependent upon network morphologies as shown in FIGS. 16G and 16H. It is observed that while temporal motion correlation remains similar, the spatial motion correlation dropped. Furthermore, it is observed that drug induced fragments move considerably faster compared to control as shown in FIG. 16I. In FIG. 16I, the DMSO control 1630 and the oligomycin 1640 are shown.

### Mitochondrial Network Tracking Reveals Local Fission and Fusion Fingerprints and Asymmetric Fission and Fusion Preferences

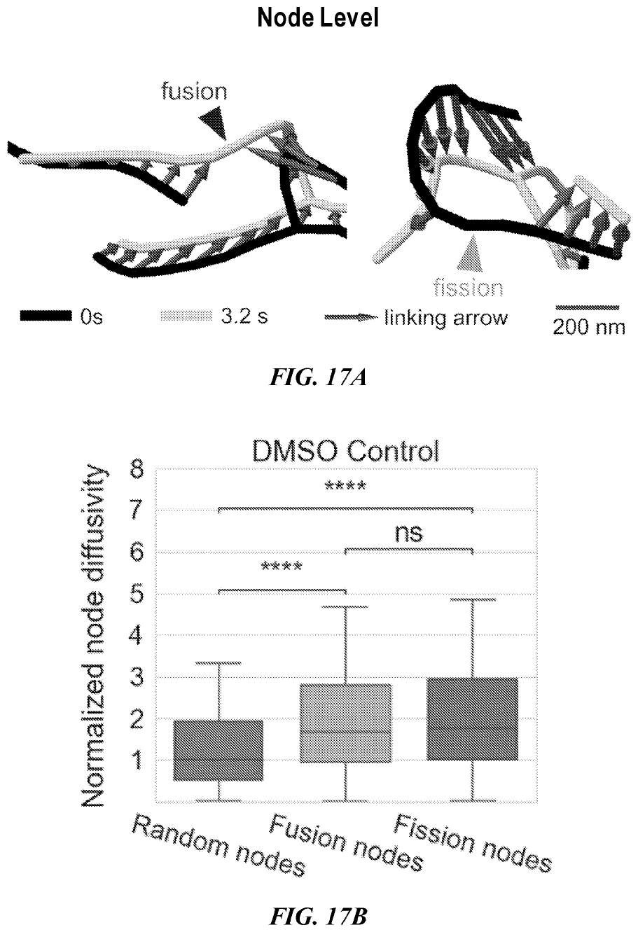

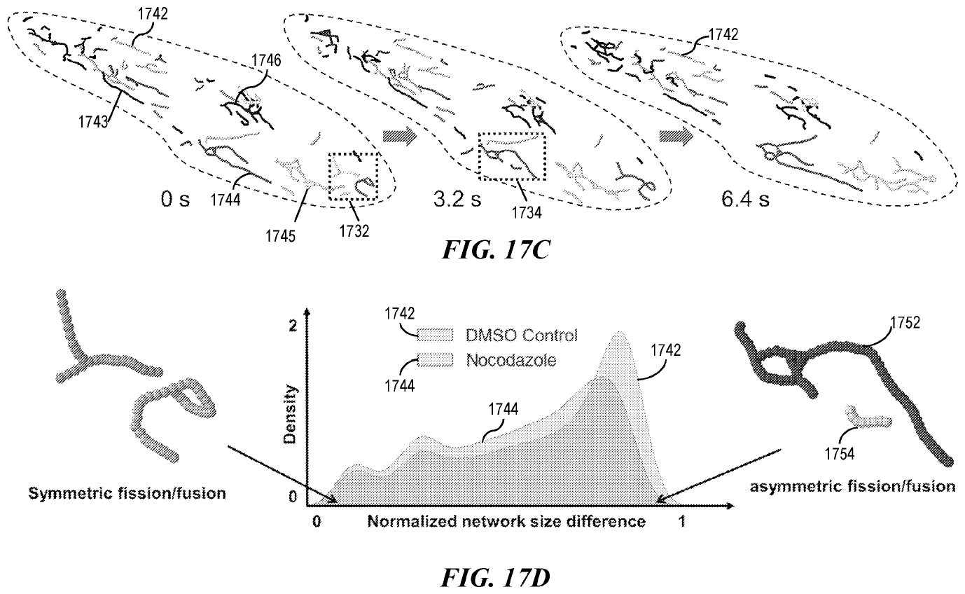

The high-resolution network tracking allows to precisely locate fission and fusion events in the mitochondrial network with sub-fragment spatial resolution and high temporal fidelity as shown in FIG. 17A.

FIG. 17A shows representative snapshots of tracked fusion event (left), and fission event (right). FIG. 17B shows that node diffusivity is significantly lower for randomly selected nodes as compared to nodes undergoing fusion and fission. Student's t-test used, and p-values are 6.565E-25, and 1.237E-24, for random vs. fusion nodes and random vs. fission nodes, respectively. FIG. 17C shows representative tracking of mitochondrial fragments in hiPSCs over three timepoints. Different lines 1742 to 1746 indicate multiple fragments. FIG. 17D shows an analysis of fission/fusion preferences with respect to fragment size shows that asymmetric fission/fusion events are more likely to occur. In FIG. 17D, the DMSO control 1752 and the Nocodazole 1754 are used. This pattern is less pronounced but preserved in nocodazole-treated hiPSCs with disrupted microtubules.

### Fission/Fusion Detection

To detect fission and fusion events in the network, a sliding-window approach is applied to identify nodes that undergo persistent structural changes as opposed to transient segmentation variations. First, the fragment indices for each node are recorded for the half win size frames before and after the current frame, to form the fragment list. Second, for each network edge, the fragment lists for the connected nodes are compared. Fission will be declared if the fragment lists before the current frame are strictly identical, as well as the fragment lists after the current frame are strictly non-overlapping. Since fusion events can be considered as fission events reversed in time, the opposite criterion is used for fusion detection. In the case that multiple remodeling nodes are located in proximity (less than 5 edges away), the nodes are grouped into a single fission/fusion site. At last, the center of the sliding window is moved to the next frame and the computation is iterated.

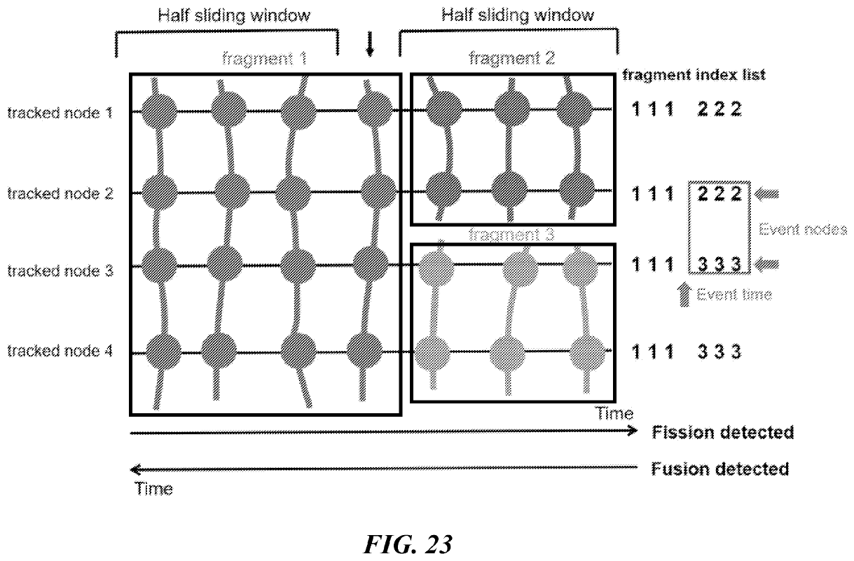

FIG. 23 shows an algorithm for fission/fusion detection based on node tracking Four tracked nodes are positioned vertically, and seven timepoints are shown horizontally. The center of the sliding window is highlighted with the arrow on top. Three fragments are labeled differently as fragment 1, fragment 2, and fragment 3. The fragment indices for each node over time are stored. For each half-window, the index values between every two connected nodes are compared frame by frame. An event is declared if fragment indices in one sliding windows are strictly different in time, while those in the other sliding window are strictly identical in time. This requirement is imposed in order to avoid misidentifying transient segmentation noise as remodeling events.

To provide mechanistic insights into network remodeling, the motility between randomly selected nodes and nodes undergoing fission and fusion was compared. It is observed that diffusivity for nodes undergoing fission and fusion is nearly two times the diffusivity for randomly chosen nodes as shown in FIG. 17B. This data suggests that mitochondrial fission and fusion remodeling might involve local rearrangements at the event site as suggested previously. Based on node tracking, each individual mitochondrial network fragment can be tracked as shown in FIG. 17C and the selectivity of fission and fusion events recorded in terms of fragment size. For each fission or fusion event, the normalized network fragment size difference was computed, with values close to 0 corresponding to a symmetric fission/fusion as shown in the left side of FIG. 17D, and values close to 1 indicating fragments of drastically different sizes (asymmetric fission/fusion) as shown in the right side of FIG. 17D. It is found that there is a significant portion of asymmetric fission/fusion events (see 1752 in FIG. 17D). Asymmetric fission/fusion events between large healthy mitochondria and small unhealthy mitochondria have been proposed to separate dysfunctional mitochondria targeted for mitophagy, or rescue damaged mitochondria by supplying essential materials. It is hypothesized that this dynamic selectivity bias is facilitated by the cytoskeleton. In cells treated with 10 μM of nocodazole to disrupt microtubules, a decrease in asymmetric fission/fusion (see 1754 in FIG. 17D) was observed. This observation points to a potential role of cytoskeleton in mediating selective fission/fusion as has previously been suggested.

4D mitochondrial network tracking allows to investigate the mitochondrial network from the perspective of a graph temporal network as shown in FIG. 18A. FIG. 18A shows temporal networks display node and edge dynamics that have an influence on network transport and resilience (newly added or removed nodes/edges 1812 highlighted in white). Specifically, it is now possible to quantify a) remodeling of the mitochondrial network, b) flux across the network as it moves spatially and is being remodeled, and c) resiliency of the network to damage.

To quantify mitochondrial network remodeling, the mean degree difference (DD) and the temporal intersection (TI) were calculated. A low DD indicates a low rate of nodes breaking off from their neighbors and reconnecting with other nodes. Inversely, a low TI implies that the network is very dynamic and does undergo drastic remodeling. It is found that control hiPSCs showed a low DD of 0.28 as shown in FIG. 18B and a high TI 0.58 as shown in FIG. 18C, indicating that the network is relatively stable with relatively little turnover. FIG. 18B shows mean degree difference between control, oligomycin, and nocodazole, and FIG. 18C shows temporal intersection between control, oligomycin, and nocodazole. In contrast, when treated with oligomycin, it was observed a 0.52 DD and 0.44 TI indicating a high level of network remodeling. Cytoskeleton influences drive network remodeling events were hypothesized. However, treatment with nocodazole did not induce drastic changes in neither metric for network remodeling as shown in FIGS. 18B and 18C.

To quantify transport across the 4D mitochondrial network, a random walk on the tracked temporal mitochondrial networks was simulated and the process was measured in the form of network reachability (see “Material diffusion simulation on temporal mitochondrial networks”). Reachability for a node indicates how easily can material/information reach this node from various parts of the overall network, via the time respecting paths defined by the network tracking. In control conditions, it is observed that almost every part of the network was in reach within ˜120 s as show in FIG. 18D and that network nodes showed a low average reachability of 0.18 as shown in FIG. 18E. Comparatively higher reachability was reached with nocodazole (0.29), mdivi-1 (0.35), and in particular with oligomycin (0.64). FIG. 18D shows global network reachability in a representative somatic mitochondrial network depicted as a brightness gradient (dark: high reachability, light: low reachability). FIG. 18E shows global network reachability where the top 5% highest betweenness-centrality nodes were removed.

To quantify mitochondrial network resiliency, mitochondrial node reachability was calculated in networks where the top 5% of highest connected nodes were removed, as measured by betweenness of centrality. It is observed that the global reachability for a large number of nodes was significantly reduced, particularly those isolated from the larger well-connected fragments. This observation suggests certain central nodes may be essential to the material and information transport within the cellular mitochondrial network as shown in FIG. 18F. FIG. 18F shows mean normalized global reachability in different drug induced conditions. In FIG. 18F, triplets indicate no nodes removed (left), 5% random nodes removed (middle), and 5% most connected nodes removed (right). To quantify the relationship between network motility, remodeling, and reachability, the Pearson's correlation coefficients were calculated between the mean normalized global reachability, the mean node displacement as shown in FIG. 18G, and the node TI as shown in FIG. 18H. The positive correlation with node displacement, and negative correlation with TI suggests that long-range movements and enhanced network remodeling both lead to quicker percolation through the network. FIGS. 18G and 18H indicate correlation of network reachability with node MSD and temporal intersection.

### Material Diffusion Simulation on Temporal Mitochondrial Networks

Diffusion simulation was used on temporal dynamic mitochondrial network to understand the flow of material in mitochondrial networks. To calculate global reachability, we initiate a virtual token at every node of the mitochondrial network at the first timestep. Each token is labeled by the source node from which it originated. At every timestep, each node duplicates the tokens it currently has, and transfers them to the connected neighbors. At the end of the simulation, the global reachability for each node is quantified by the number of unique tokens at that node, corresponding to the number of source nodes this node can reach.

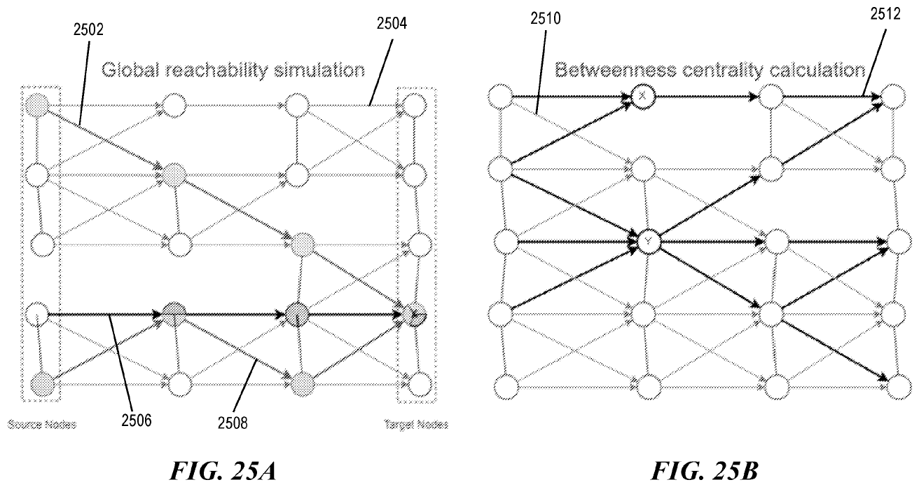

FIGS. 25A and 25B illustrate schematics for material diffusion simulation on temporal network. FIG. 25A illustrates the global reachability simulation. From each node, material can diffuse into the neighboring nodes or stay in the source node. All possible diffusion pathways over time are marked with an arrow. Time is depicted from left to right. Arrows in different thicknesses 2502, 2504, 2506, 2508, 2510, 2512 indicate representative simulation scenarios. After four timesteps, the target node labeled with X has accumulated three tokens (through the transport arrows). FIG. 25B illustrates the calculation for betweenness centrality used for determining the central nodes.

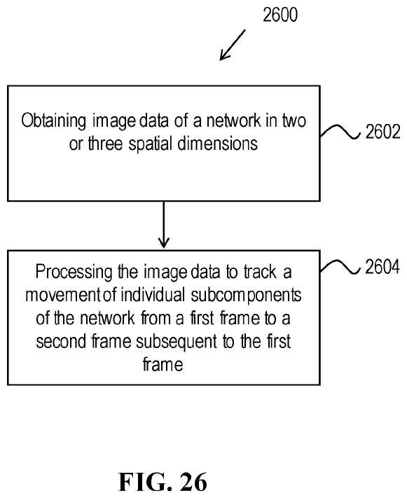

FIG. 26 shows an example flowchart of a method for temporal tracking of cellular structures including organelle networks in fluorescence microscopy data. The method comprises obtaining 2602 image data of a network in two or three spatial dimensions; and processing 2604 the image data to track a movement of individual subcomponents of the network from a first frame to a second frame subsequent to the first frame.

In this example implementations, MitoTNT, the first-in-class software for mitochondrial temporal network tracking in 4D volumetric fluorescence microscopy data is presented. Recent advances in low phototoxicity volumetric live cell imaging allow fast high-resolution acquisition of the somatic mitochondrial temporal network. MitoTNT allows the automated tracking of this temporal network for the first time. Based on mitochondria skeleton segmentation and discretization through MitoGraph, MitoTNT solves the linking problem of discretized mitochondria skeleton nodes through time. An efficient, alignment-based graph comparison algorithm was used to capture network topology information and pair it with distance constraints for temporal linking. Tracking was validated using both in-silico and in-vitro methods. Polymer-based spatial mitochondrial simulations were created to include fission and fusion reactions and are parameterized to reproduce experimental observations to quantify the tracking fidelity of the suggested algorithm. It is found that MitoTNT performs with >90% tracking accuracy on these datasets. When comparing tracking performance on experimental in-vitro datasets, it is found that MitoTNT faithfully tracks the 4D mitochondrial network and reproduces experimental observables such as mitochondrial diffusivity and speed as compared to published values in the literature. Based on fluorescence microscopy and computational image segmentation, MitoTNT is limited by a microscope's ability to record high signal to noise volumetric images of the mitochondrial network to ensure high quality segmentation. Future efforts might use advances in machine learning to improve segmentation quality and reliability.

MitoTNT were highlighted to the following analyses including 1) high-resolution mitochondria network motility analysis, 2) node-level mitochondrial fission/fusion analysis, and 3) mitochondria temporal network analysis. For motility analysis, the previously hidden complexity of sub-fragment motility can now be characterized. By coupling network sub-compartment motility with other mitochondrial fluorescence readouts (e.g., membrane potential, reactive oxygen species, mtDNA nucleoid), future studies employing network tracking will have the potential to investigate the functional aspects of mitochondrial motion in cellular physiology.

For node-level fission/fusion analysis, we showed that mitochondrial fission and fusion dynamics can be registered at sub-fragment resolution. Compared to fission/fusion detection for object based tracking, the suggested approach is highly versatile in distinguishing sub-types of mitochondrial remodeling events such as kiss-and-run events, sustained fission/fusion events, intra-fragment events, and inter-fragment events. The high spatio-temporal resolution offered through mitochondrial network tracking will become instrumental in studying selective fission/fusion and mitochondrial quality control.

The characterization of somatic mitochondrial networks as temporal networks through MitoTNT allows using the full power of mathematical models for graph temporal networks for mitochondria analysis, for example determining community formation within the mitochondrial network, understanding the efficiency of metabolic flow, or characterizing various cell types and states using network motifs. By combining 4D fluorescence imaging, network tracking, and functional simulation, cellular metabolic state profiling based on microscopy data can now be conducted, opening the door for high-content screening of such states. Mito TNT's extendable software design and open-source code availability will contribute to forming a community around mitochondria temporal network tracking and will allow the field to quickly explore the indicated directions.

In the implementations above, the following considerations are made.

Human induced pluripotent stem cell (hiPSC) culture: All studies involving hiPSCs were performed under approval from the University of California San Diego IRB/ESCRO committee. WTC hiPSCs expressing the CAAX domain of K-ras tagged with m TagRFP-T were created at the Allen Institute for Cell Science and obtained through the UCB Cell Culture Facility. hiPSC colonies were expanded on dishes coated with growth factor reduced Matrigel (Corning, 354230) in mTeSR1 (Stemcell Technologies, 85850) containing 1% penicillin/streptomycin (Gibco, 15140122). Colonies were washed with DPBS (Gibco, 14190144) and detached with accutase (Stemcell Technologies, 07920) before plating onto imaging dishes. Cultures were tested routinely for mycoplasma.

Drug Treatments: All drugs were dissolved in DMSO to make a stock solution and diluted in PBS to prepare a 100× working stock. Cells were treated with oligomycin (20 μM, 2 hr), nocodazole (5 uM, 30 min), and MDIVI-1 (10 μM, 12 hr) without wash.

Live cell imaging: 371 CAAX-RFPhiPSCs were stained with 100 nM Mito Tracker Green FM (Invitrogen, M7514) for 30 min prior to imaging. Cells were plated onto 25 mm MatTek dishes and imaged in phenol-red free mTeSR1 (Stemcell Technologies, 85850). Cells were kept under 5% CO2 and 37 degrees C. For imaging, Zeiss LLSM 7 was used with 10×N.A. 0.4 illumination objective lens and 48×375 N.A. 1.0 detection objective lens. Images were acquired in two channels: green channel with excitation at 488 nm and emission at 512 nm; red channel with excitation at 561 nm and emission at 597 nm. For both channels we used 18% laser power and 8 ms exposure. The illumination light-sheet was the Sinc3 beam with length 15 μm, thickness 650 nm and no side lobes. The volume size was 2048×448×57 pixels or 296.94×64.96×8.12 μm with isotropic pixel size 145 nm after coverglass transformation. Images were saved with bit depth 16 bits. For each region, 93 frames were imaged with frame rate 3.26 s per volume for total 5 min. For LLSM data processing, the Lattice Lightsheet 7 Processing Module on ZEN Blue was used for deconvolution, deskew, and cover glass transformation. Further processing is then done using MitoGraph and MitoTNT.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the singular forms “a”, “an” and “the” are intended to include the plural forms as well, unless the context clearly indicates otherwise. Additionally, the use of “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method for temporal tracking of cellular structures including organelle networks in fluorescence microscopy data, comprising:
obtaining image data of a network in two or three spatial dimensions; and
processing the image data to track a movement of individual subcomponents of the network from a first frame to a second frame subsequent to the first frame.

2. The method of claim 1, wherein processing the image data includes tracking the movement of the individual subcomponents of the network for additional frames until the organelle network is tracked temporally through an entire time course of a dataset.

3. The method of claim 1, wherein processing the image data comprises obtaining a temporal network that includes topology information of the network preserved in the first frame and the second frame, the temporal network having the two or three spatial dimensions and time component.

4. The method of claim 1, wherein obtaining the image data includes obtaining the image data from images that are taken at regular time points.

5. The method of claim 4, wherein obtaining the image data includes obtaining the image data by lattice light-sheet microscopy (LLSM) or confocal microscopy.

6. The method of claim 1, wherein processing the image data includes:
segmenting the image data to obtain consecutive volumetric images of the network.

7. The method of claim 1, wherein processing the image data includes:
discretizing the network into individual nodes along a skeleton of the network, each node connected to neighboring nodes on the skeleton and having spatial coordinates and tubular width, and
assigning features of the network to the individual nodes between the first frame and the second frame.

8. (canceled)

9. The method of claim 1, wherein processing the image data further includes obtaining a cost matrix for a linear assignment problem (LAP) to capture temporally preserved properties of each subcomponent of the network.

10. The method of claim 9, wherein processing the image data further includes:
constructing a node dissimilarity score matrix for pairs of the nodes in two frames among the first frame, the second frame, and additional frames; and
applying the linear assignment problem using the cost matrix.

11. The method of claim 10, wherein the cost matrix is based on a spatial distance between nodes within the first frame and the second frame and a topology cost assigning a low cost for maintaining a local topology for a certain time window.

12. The method of claim 1, wherein processing the image data includes:
linking two nodes between the first frame and the second frame to obtain a linked node pair, and wherein processing the image data further includes at least one of: terminating a node in the first frame or initiating a new node in the second frame.

13. (canceled)

14. The method of claim 1, wherein the network includes a mitochondrial network, an endoplasmic reticulum, a microtubule network, or an actin cytoskeleton.

15. The method of claim 1, wherein the first frame and the second frame are separated by a time amount that allows a correlation between the network in the first frame and the second frame.

16. (canceled)

17. A device including a processor to perform a method for temporal tracking of cellular structures including organelle networks in fluorescence microscopy data, wherein the method comprises:
segmenting a network fluorescence signal to obtain a segmented network skeleton using a fluorescence signal;
tracking a movement of nodes of the segmented network skeleton from a first frame to a second frame subsequent to the first frame.

18. The device of claim 17, wherein the network fluorescence signal is segmented using lattice light-sheet microscopy (LLSM) or confocal microscopy.

19. The device of claim 17, wherein the tracking the movement includes linking three-dimensional pixels of the network from a first timepoint corresponding to the first frame to a second timepoint corresponding to the second frame.

20. The device of claim 17, wherein the method further comprises:
locating a fission event and a fusion event in the network based on a result of the tracking.

21. (canceled)

22. The device of claim 17, wherein the method further comprises:
assigning features of the segmented network skeleton to nodes between the first frame and the second frame using a cost matrix for linear assignment problem (LAP) to capture temporally preserved properties of the segmented network skeleton.

23. The device of claim 22, wherein assigning the features of the segmented network skeleton includes:
constructing a node dissimilarity score matrix for pairs of the nodes in two frames among the first frame, the second frame, and additional frames; and
applying the linear assignment problem using the cost matrix.

24. The device of claim 22, wherein the cost matrix is based on a spatial distance between nodes within the first frame and the second frame and a topology cost assigning a low cost for maintaining a local topology for a certain time window.
